(19) United States
(12) Patent Application Publication
(10) Pub. No.: US 2025/0273085 A1
(43) Pub. Date: Aug. 28, 2025

(54) CONTENT ORGNIZATION AND OPTIMIZATION METHODS AND SYSTEMS

(71) Applicant: Feng Ma, Cary, NC (US)

(72) Inventor: Feng Ma, Cary, NC (US)

(21) Appl. No.: 19/063,280

(22) Filed: Feb. 25, 2025

Related U.S. Application Data
(60) Provisional application No. 63/557,595, filed on Feb. 25, 2024.

(51) Int. Cl. G09B 9/08; G06Q 30/0241; G06Q 30/04; G06Q 50/26

(52) U.S. Cl. CPC G09B 9/08; G06Q 30/0277; G06Q 30/04; G06Q 50/26

(57) ABSTRACT

A method for organizing and delivering content includes: searching for online content based on specification or preference of a user; automatically categorizing and organizing content based on authority specifications; delivering the automatically categorized and organized content to the user; collecting fees from user for part of the automatically categorized and organized content that require the fees; and automatically distributing royalties to content owners from the collected fees.

### CROSS-REFERENCE TO RELATED APPLICATIONS

The present disclosure claims priority to U.S. Provisional Patent Application No. 63/557,595 filed Feb. 25, 2024, the disclosure of which is hereby incorporated by reference in its entirety.

### BACKGROUND

Digital contents are often organized according to various specifications, and presented to readers/users in the form of digital documents, books, videos, etc. Conventional book publishing involves an author writing up a substantial content first, and then seeks a publisher. Conversely, a publisher may seek potential writers to have the writers write books of the publisher's interest or of the writers' expertise. A typical agent may contact a writer, or vice versa, and the agent helps the individual writer to publish books through a publisher.

### SUMMARY

In an aspect, embodiments disclosed herein relate to a method for publishing, including establishing a business entity, the business entity identifying a plurality of clients who desire to have their proposed works published, subcontracting the works to one or more writers, and publishing the works for the clients.

In another aspect, a method for organizing and delivering content is provided, including: searching for online content based on specification or preference of a user; automatically categorizing and organizing content based on authority specifications; delivering the automatically categorized and organized content to the user; collecting fees from user for part of the automatically categorized and organized content that require the fees; and automatically distributing royalties to content owners from the collected fees.

Other aspects and advantages of the invention will become apparent from the following description and the attached claims.

Embodiments of the present invention are described in detail below with respect to the drawings. Like reference numbers are used to denote like parts throughout for consistency.

### BRIEF DESCRIPTION OF THE DRAWINGS

FIG. 1 is a block diagram illustrating relationships among a business entity, clients, and writers in accordance with some embodiments of the present disclosure.

FIG. 2 illustrates an example published work package.

FIG. 3 is a flowchart illustrating a preferred method in accordance with some embodiments of the present disclosure.

FIG. 4 is a schematic diagram illustrating a publishing method according some embodiments of the present disclosure.

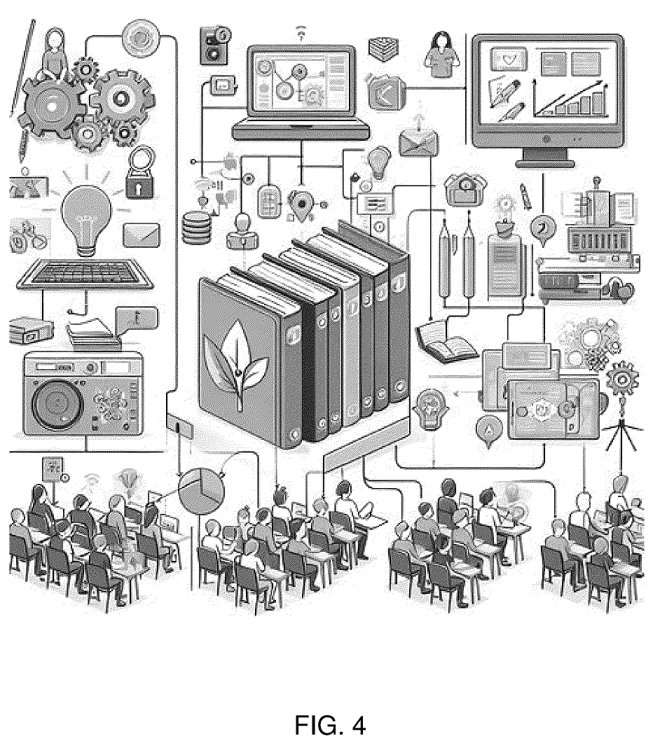

FIG. 5 is a schematic diagram illustrating a content organization and delivering method according some embodiments of the present disclosure.

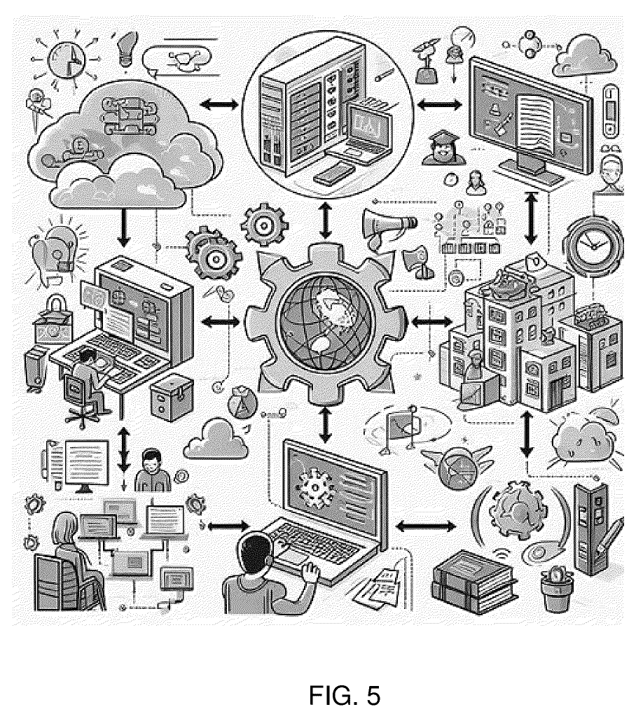

FIG. 6 is a schematic diagram illustrating a voting method and system according some embodiments of the present disclosure.

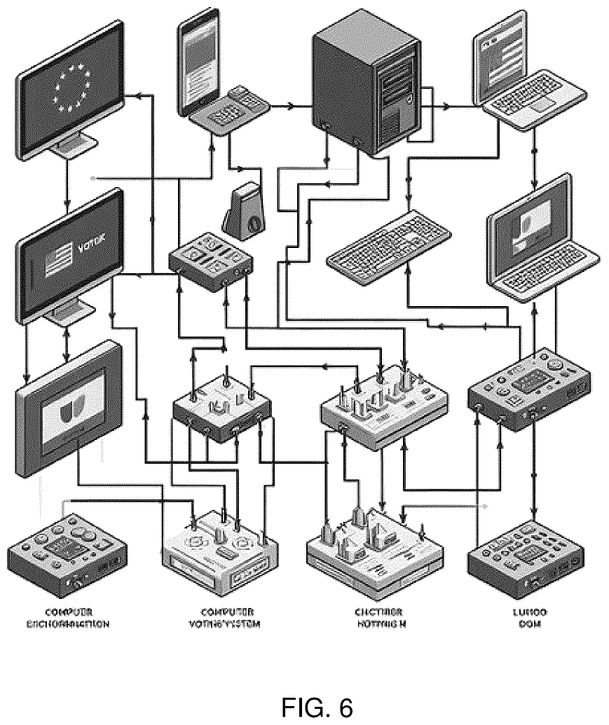

FIG. 7 is a block diagram illustrating a voting system according some embodiments of the present disclosure.

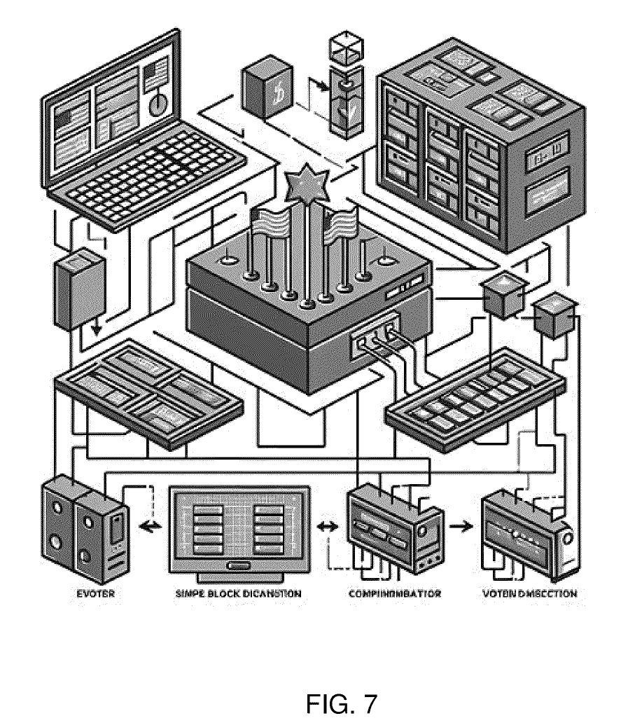

FIG. 8 is a block diagram illustrating a traffic monitoring and autopiloting system and method according some embodiments of the present disclosure.

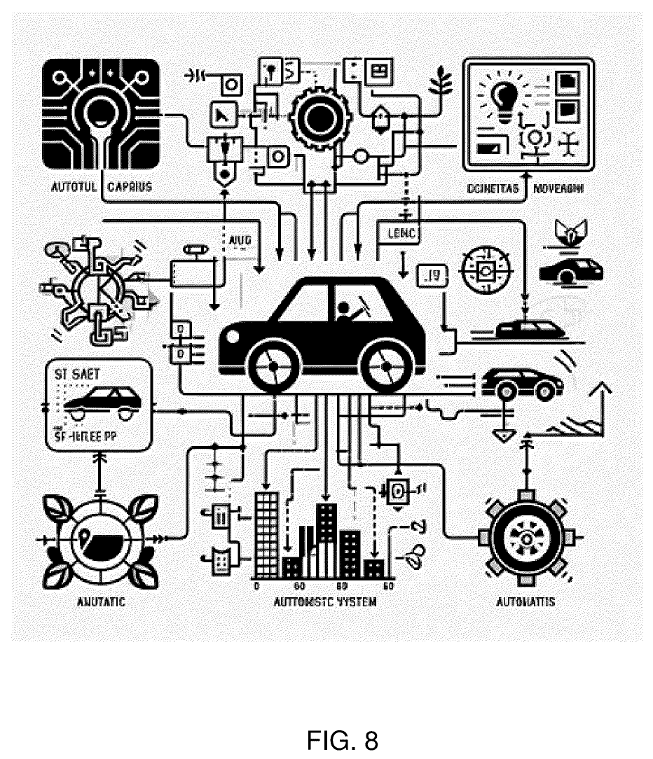

FIG. 9 is a schematic diagram illustrating a traffic monitoring and controlling system and method according some embodiments of the present disclosure.

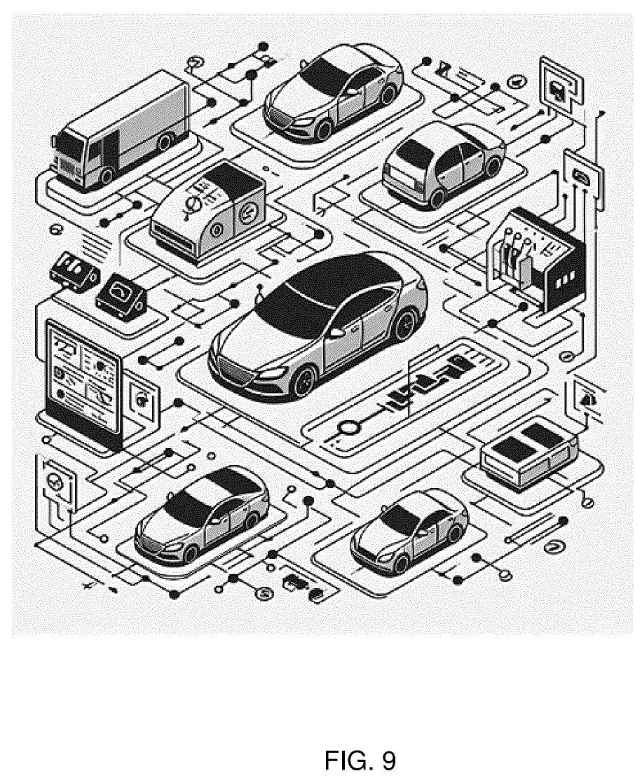

FIG. 10 is a block diagram illustrating a content delivering system and method according some embodiments of the present disclosure.

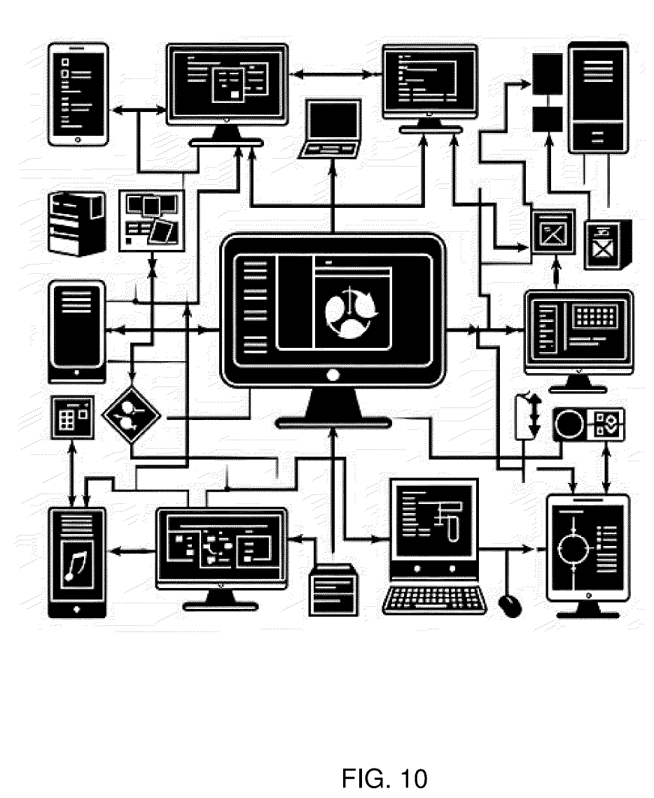

FIG. 11 is a block diagram illustrating a simulation system and method according some embodiments of the present disclosure.

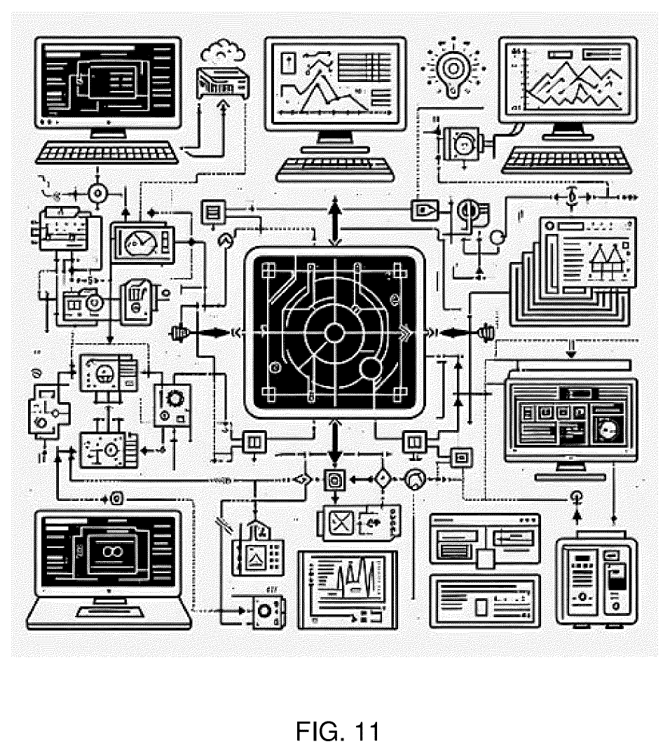

FIG. 12 is a schematic diagram illustrating a bird warning system for wind turbines according some embodiments of the present disclosure.

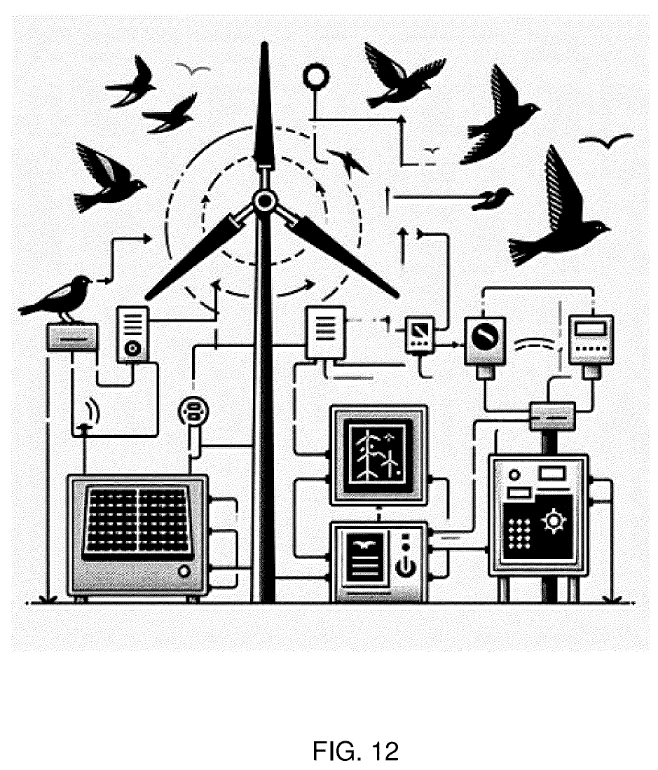

FIG. 13 is a schematic diagram illustrating an operation of the bird warning system for wind turbines according some embodiments of the present disclosure.

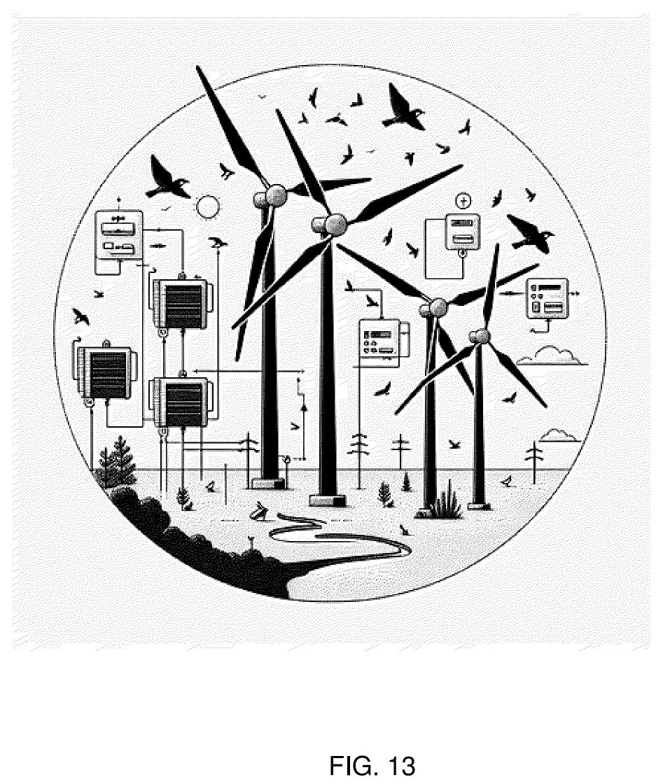

FIG. 14 is a schematic diagram illustrating a flight simulation, tracking, and training system according some embodiments of the present disclosure.

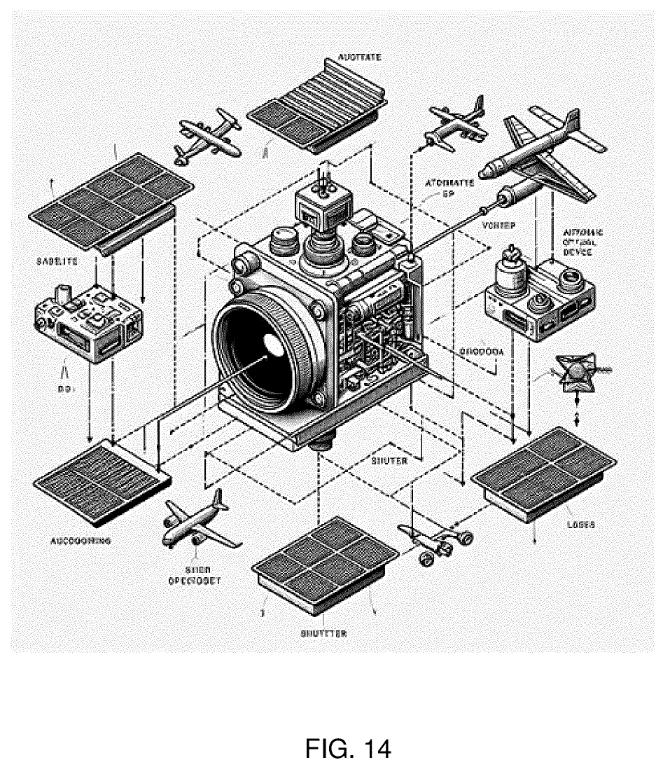

FIG. 15 is a schematic diagram illustrating an automatic shutter apparatus based flight and tracking according some embodiments of the present disclosure.

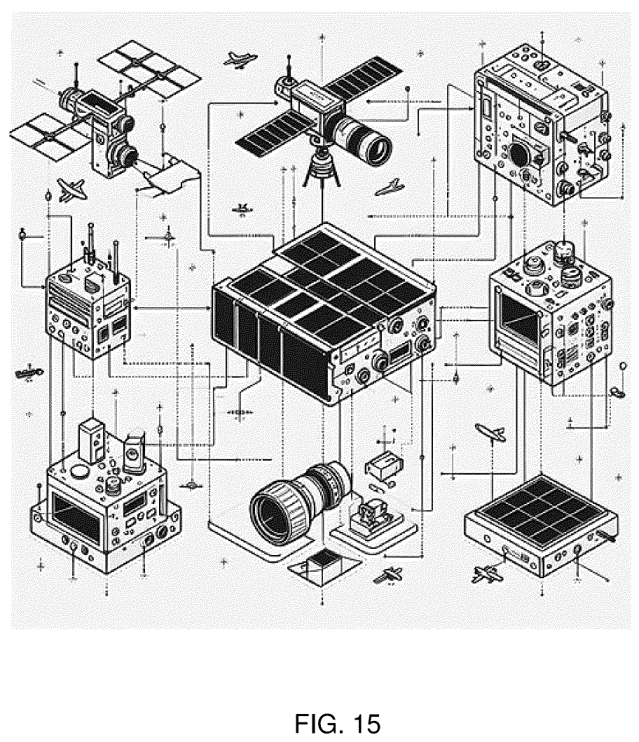

FIG. 16 is a schematic diagram illustrating an AI-based physician assistant and content organization and distribution system and method according some embodiments of the present disclosure.

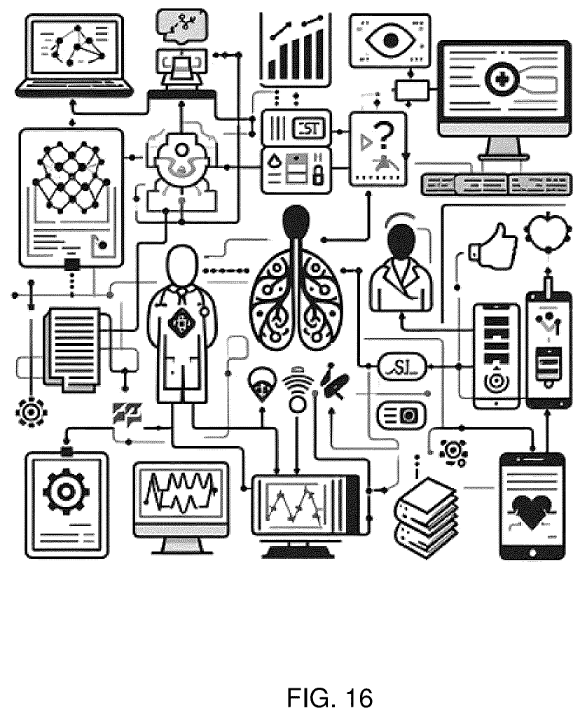

FIG. 17 is a schematic diagram illustrating an AI-based physician assistant utilizing simulation-based optimization process according some embodiments of the present disclosure.

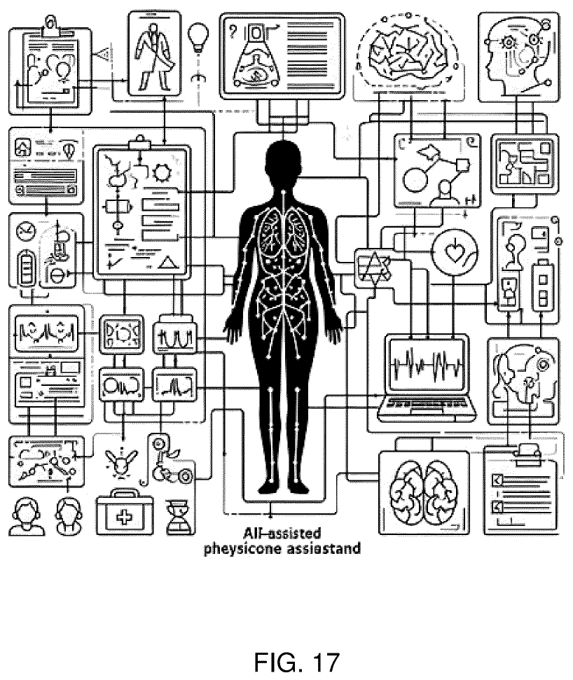

FIG. 18 is a schematic diagram illustrating an automatic dog leash apparatus according some embodiments of the present disclosure.

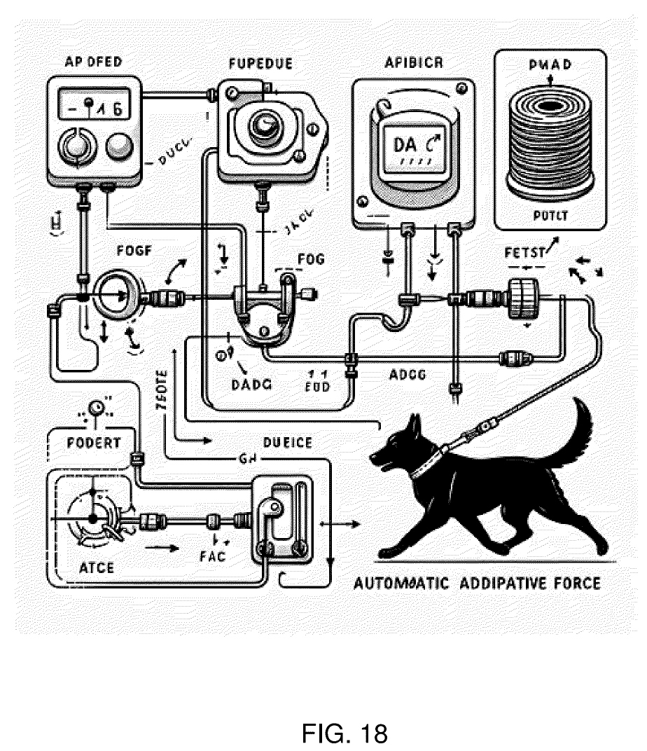

FIG. 19 is a schematic diagram illustrating an operation of an automatic dog leash system according some embodiments of the present disclosure.

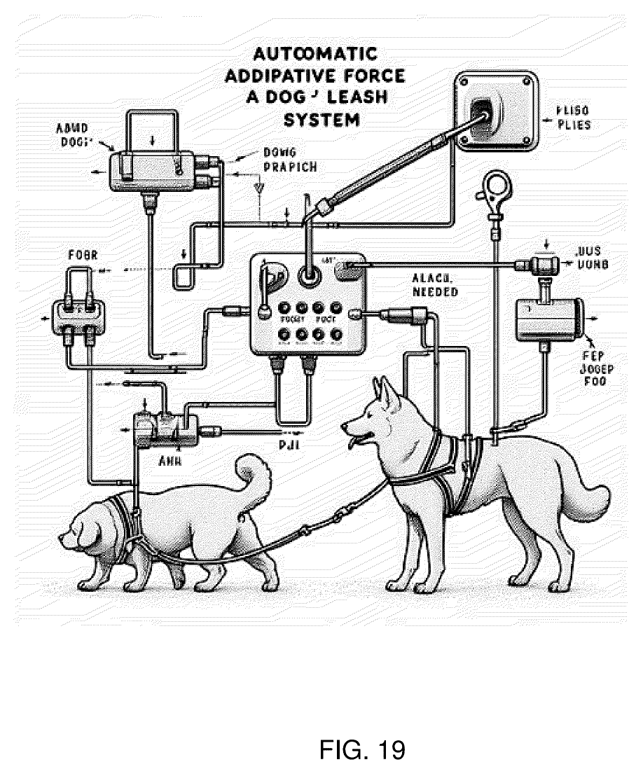

FIG. 20 is a schematic diagram illustrating various operation scenarios of an automatic dog leash system according some embodiments of the present disclosure.

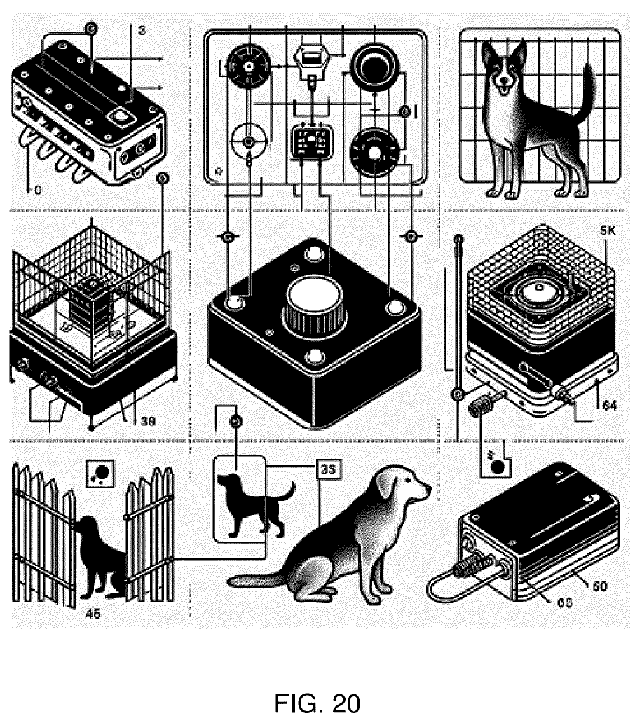

FIG. 21 is another schematic of an automatic dog leash apparatus according some embodiments of the present disclosure.

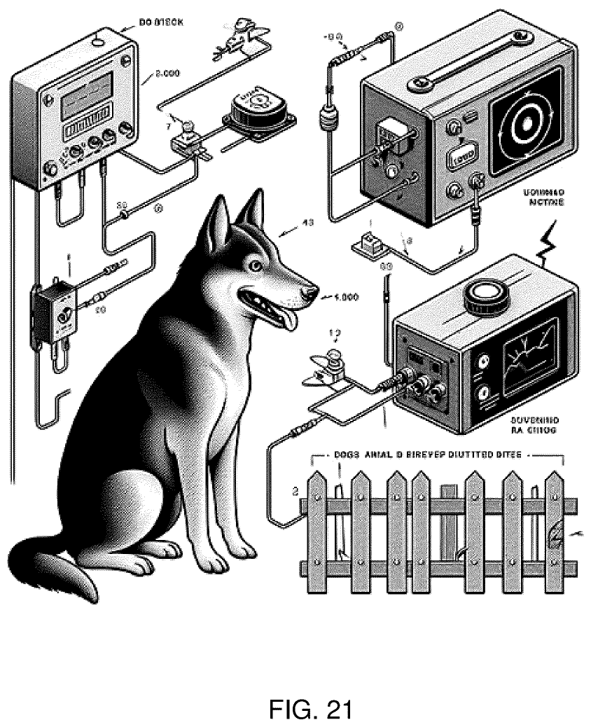

### DETAILED DESCRIPTION

Embodiments are described in detail below with respect to the drawings. Like reference numbers are used to denote like parts throughout for consistency.

The following description is provided to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the present invention. Thus, the present disclosure is not intended to be limited to the embodiments shown, but is to be accorded the widest scope consistent with the principles and features disclosed herein.

In one aspect, some embodiments disclosed herein relate to methods for cost effectively publishing books or other works for individuals. Many individuals, especially senior citizens, are interested in publishing, for example, autobiographies, or other works. The published work, such as an autobiography, satisfies greatly an individual's desire to leave some marks on the world. A published autobiography, nicely printed, which may include life stories as told by the individual, with illustrations such as maps, chronology, family trees, and photos, can be used as gifts to give to the individual's children, family members, and friends. Some of the books may even be sold in bookstores or distributed online.

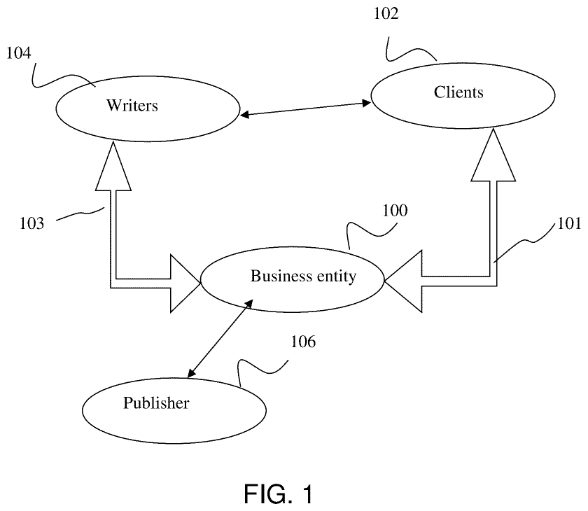

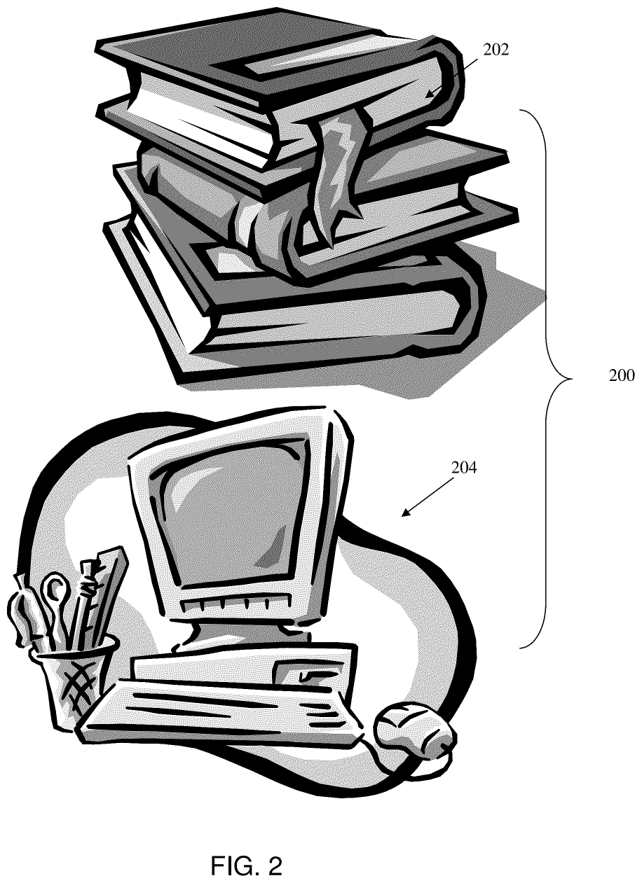

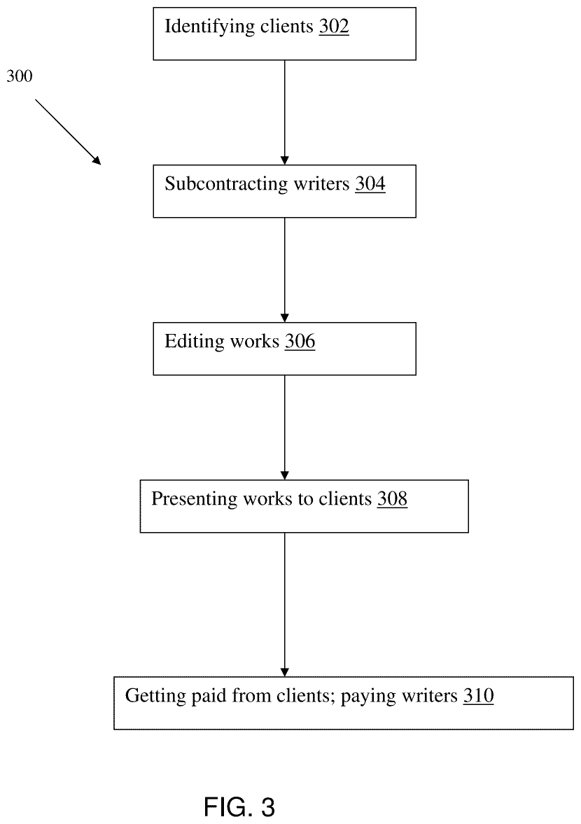

FIG. 1 is a block diagram illustrating relationship among a business entity, clients, and writers in accordance with an embodiment of the disclosure. FIG. 2 illustrates an exemplary published work package. FIG. 3 is a flowchart illustrating a preferred method in accordance with embodiments of the disclosure.

Referring to FIG. 1, a business entity 100 in accordance with an embodiment of the invention targets and identifies a plurality of potential clients 102. The potential clients 102 may be, for example, senior citizens who want to have their autobiographies written and published, and creative individuals who want to have their works published. These potential clients may not wish, or do not have the time, to write, compile, edit, and publish the works themselves. The plurality of potential clients may be identified by advertising service of the business entity 100 on a website, and identifying the plurality of clients from the potential clients' response to the advertisement The potential clients may also be identified by other forms of advertising, such as visiting senior citizen communities, telephone calls, and fliers. Such advertising may also be achieved, for example, during conventions and other public events. For example, during auditing process for TV shows, such as American Inventors, American Idols, etc., where thousands of potential clients line up to be audited. These potential clients fit in a category of people who tend to be more self-expressing. The business entity 100 may send representatives to talk to the potential clients while they are waiting in line, sending out fliers, or even signing contracts on the spot.

Online “match making” may also play a role in making connections between the business entity 100, the clients 102, and the writers 104. The business entity 100 may set up a website, advertising to potential clients 102, while collecting and maintaining a pool of writers.

The business entity 100 may exchange information and/or deposits, shown as block arrow 101, with the clients 102. The information and/or deposits 101 may include, for example, an initial quote on prices, contract, or monetary deposits. Preferably, the clients 102 provide a deposit to the business entity 100 to retain the service of having the clients' 102 works published.

After having contracts with clients 102, the business entity identifies writers 104 from a pool. For those clients 102 who desire to have their works such as their autobiographies published economically, the writers 104 may be found from junior and/or part-time writers, such as college students who wish to work part time as writers. For those clients 102 that cost is less an issue, and the works desired to be published, such as fictions, which often need more effort on the side of the writers 104 than do the autobiographies, the writers 104 may be found from a network of professional writers. A pool of at least five writers and five clients, and preferably at least ten writers and at least ten clients, are needed to maintain the healthy business entity 100 with healthy cash flow.

The business entity 100 also exchanges information and materials, shown as block arrow 103, with the writers 104. The information 103 may include, for example, guidelines from the business entity 100 to the writers 104 on the format and the quality standard of the works to be published, and contracts between the writers 104 and the business entity 100. The business entity may supply, for example, recorders, laptop computers with recording functions, scanners, cameras and/or camcorders, computer readable storage media, editing software, etc. Alternatively, the writers 104 may provide their own supplies.

The business entity 100 contracts the works to the writers 104, and help the writers 104 and the clients 102 establish and maintain connections 105. The connections 105 may be in the form of, for example, the writers 104 visit with the clients 102 one or more times. Preferably the writers 104 visit the clients 102 regularly, for example, on a weekly or monthly basis. During the visits or through telephone conversations, the writers 104 communicate with the clients 102. The clients 102 tell their stories, which may be recorded by the writers 104. The clients 102 may also provide substance of their works or stories in other forms, such as pictures and sounds. If the clients' pictures are not already in digital form, the writers 104 can scan such pictures and save the pictures in their computers.

Clients 102, especially senior citizens, would appreciate some young writers 104 such as college students visiting them regularly, and listening to their stories. Meanwhile, the clients 102 establish a goal for themselves of leaving something, such as autobiographies, to the world. In one example, the writers 104 visit the clients 102 on a weekly basis, and collect “raw” materials such as voice recording, pictures, and video clips. During the week, the writers 104 write up portions of the autobiographies, such as sections or chapters of books. Preferably the autobiographies are written in the form of stories as told by the clients 102, about their lives, with reference to photos, maps, chronological lists, tables, family trees etc., as parts of the books. The writers 104 send the sections or chapters to the business entity 100. The business entity 100 evaluates the quality of the sections or chapters, and pay the writers 104 based on the quality and/or the time and effort the writers 104 spent as progress report. The payment from the business entity 100 to the writers 104 may be made, for example, on a weekly, monthly, or quarterly basis, or in a lump sum. The business entity 100 sends progress reports, which may include the edited sections and chapters in digital form, to the clients 102 for their record. The clients 102 may also pay the business entity 100 on a regular basis based on the progress of the writings.

Once the autobiography for a certain client 102 is completed, the business entity 100 contracts a publisher 106 to publish the book, and may order a predetermined number of copies from the publisher 106 or from an independent printing facility 108. Alternatively, the business entity 100 may publish and print the books internally. The number of prints depend on the desire of the client 102. The cost of printing may be billed to the client separate from other charges.

FIG. 2 illustrates an exemplary published work product package 200. As shown, the work product package 200 may include printed books 202, which may be included in the basic package of the work 200. For some more investment from the client 102, the work product package 200 may include a DVD (not shown), or other form of media. In the DVD or other media, video clips or sound recording, with some background music, may be included. In a “deluxe” version for example, the work package 200 may include a website 204 with multimedia content adapted from the book 202 or the media such as DVD. Although the published work package 200 is primarily for the satisfaction of the clients 102 and used as a gift idea, the more unique ones may be used for stories, novels, movies, and reality TV series. For example, a reality TV show “My Story My Life” may be devised based on the work package 200, with the clients 102 narrating themselves, which may attract a substantial number of audience who resonant with the stories told by the clients 102. The work product package 200 may have the client as the sole author, or have the writer as a co-author.

In the case of co-authorship, the writers get their paid while writing and getting co-authorship together with the clients. The co-authorship may motivate the writers to write with their full potential because the published products may reflect their interests and their clients' as well. The co-authorship may serve as a quality-proof to their future clients.

FIG. 3 is a flowchart illustrating a preferred method 300 in accordance with embodiments of the invention. In step 302, the clients are identified. Work contract may be established between the business entity and the clients. In step 304, the works are subcontracted to writers as discussed above. In step 306, the works are edited. In step 308, the edited works are presented to the clients. In step 310, the business entity gets paid by the clients, and may pay the writers. By attracting a large number of clients, and having a large pool of writers especially junior part-time writers, the cost of the process is reduced. By contracting publishers and printing facilities, the publishing and printing cost is further reduced. The work product may be published in a small quantity, for example, about 100 copies, which can be used by the clients as gifts to their children, family members, and friends, and may be donated to libraries and museums. For those work product of sufficient interest to the market, the package may be commercialized, and more copies published and distributed through bookstores and websites.

Advantages of one or more embodiments of the present invention may include, but are not limited to: improved cost effectiveness of getting ones' works such as autobiographies published; reduced cost for printing a relatively small number of prints as the business entity may have a plurality of clients and the final sum of the total prints are in large quantity. The individual clients can have their works such as autobiographies published on a relatively low cost even if the clients only order a smaller number (e.g., 100) of prints. The business entity effectively bound the people who desire to get published with the people who enjoy writing or who are willing to write. Not only do the writers get to write, and get to practice their writing skills, they are getting paid of doing so. Meanwhile, they are motivated to get the work well done because of the possibility of co-authorship, and the possibility of making a “hit” for at least some of the books published.

While various embodiments of the disclosure have been described with respect to a limited number of embodiments, those skilled in the art, having benefit of this disclosure, will appreciate that other embodiments can be advised which do not depart from the scope of the invention as disclosed herein. Accordingly, the scope of the invention should be limited only by the attached claims.

In some embodiments, a method of publishing is provided, including: identifying a plurality of clients who desire to have their proposed works published; subcontracting the works to one or more writers; and publishing the works for the clients.

The clients are those who desire to have their ideas or autobiographies published, such as senior citizens who want to publish their autobiographies.

The works comprise one or more of: books, portable media, and websites, and are in one or more of the forms: printed copy, multimedia, movie, and TV.

The method further includes a business entity getting paid by the clients, and the business entity paying the writers.

The writers are part-time writers, and are from a pool of college students.

The method further includes: the writers visiting the clients regularly; the writers presenting progress reports to a business entity; and the business entity presenting edited work products to the clients.

Identifying the plurality of clients includes advertising service of a business entity on a website, and identifying the plurality of clients from potential clients' response to the advertisement.

The writers get their work paid while writing and get their names co-authored with the client names. The co-authorship will motivate the writers to write with their full potential because the published products will reflect their interests and their clients' as well. The co-authorship will serve as a quality-proof to their future clients.

In an example, the methods and systems can be advertised as “ . . . Your Life, Your Stories . . . ; Want to leave some foot prints in the world? Write a book! Want to send the best gifts to the children? Write a book! What to have an impact on your friends' lives? Write a book! Or better yet, have your autobiography written!! We are a group of passionate writers who are ready to send one of us to visit you and interview you regularly. We record your stories, make copies of your photos, take your video clips, and write chapters of your life. We will have the chapters reviewed and edited by our editors before having you to review them. A few months later, you will have copies of beautifully printed autobiographies, with your stories, your family histories, and photos, included, written as if you told the stories to your children. The book also comes with a CD, and we can set up a website at your request.”

In some embodiments, a display device may be included in a publishing system, which can be any suitable device that can display images or patterns in the vehicle interior, such as a liquid crystal display (LCD), a light emitting diode (LED) display, an organic light emitting diode (OLED) display, a projection device, or a holographic device.

In another aspect, an automated system and method are provided for organizing and delivering educational content to users. Specifically, the system utilizes authority-published structures, such as federal aviation administration (FAA) publications/outlines for pilots, to categorize and present relevant video and textual lessons. Users can access the content sequentially, following a structured learning path. The system also handles royalty distribution to content creators based on user fees.

Traditional online learning platforms often lack a standardized structure for organizing educational content. Users may struggle to find relevant materials or follow a coherent learning path. Additionally, content creators face challenges in monetizing their work effectively.

The automated system described herein addresses these issues by providing an organized and efficient way to deliver educational content. Various features Can include the following.

### Content Categorization:

The system automatically categorizes educational content (videos, articles, etc.) based on established authority outlines (e.g., FAA guidelines for pilot training).

Each lesson is tagged with relevant topics (e.g., “Takeoff Procedures,” “Navigation,” “Emergency Landings,” etc.).

### Structured Learning Paths:

Users select their learning objectives (e.g., obtaining a pilot's license).

The system presents a sequential learning path, guiding users through relevant lessons.

Users can view content in a logical order (e.g., “License Lesson 1,” “License Lesson 2,” etc.).

User-Generated Content: Users can contribute their own content (e.g., personal experiences, additional resources).

The system integrates user-generated content into the structured learning path.

Royalty Distribution: Users pay fees to access the content.

The system automatically distributes royalties to content creators based on usage (views, downloads, etc.).

For the content organization, the system continuously crawls the internet for relevant educational content.

It analyzes content based on keywords, relevance, and authority sources.

Content is categorized into predefined topics (e.g., “Flight Planning,” “Aircraft Systems,” etc.).

User Profiles: Users create profiles, specifying their learning goals (e.g., “Private Pilot License”).

The system tailors content recommendations based on user preferences.

Structured Learning Paths: Users select a learning path (e.g., “Pilot License Path”).

The system presents a sequence of lessons, following FAA outlines.

Users can track their progress (e.g., “Completed Lesson 3”).

User-Generated Content: Users can submit their own content (e.g., flight logs, study guides).

The system verifies and integrates relevant user-generated content into the learning path.

Royalty Management: Content creators register their work with the system.

Users pay subscription fees or per-lesson fees.

The system calculates royalties based on usage and distributes payments to creators.

Efficiency: Users access relevant content without sifting through unrelated materials.

Structured Learning: Users follow a logical progression, ensuring comprehensive understanding.

Monetization: Content creators receive fair compensation for their contributions.

The automated system described herein revolutionizes online education by providing an organized, user-friendly platform. By integrating authority outlines, user-generated content, and royalty management, it enhances the learning experience for aspiring pilots and other learners.

An automated system and method for organizing and delivering content, include: content categorization based on authority outlines; structured learning paths for users; integration of user-generated content; and royalty distribution to content creators.

For example, a user wants to learn to fly to get FAA pilot's license. Once prompted by the user requirements, the methods and the system would automatically search through all the internet such as YouTube™ and organize the video and textual lessons based on authority published structure such as FAA outlines for pilots. The user, once started, can view the lessons number one, number two, number three, etc. The system and methods can automatically distribute the royalties and fees paid by the user to the content creators.

In another aspect, the content organization involves an artificial intelligence (AI) assisted physician assistant. For example, the artificial intelligence or AI system can function through a mobile terminal or through cloud using large language model (LLM). The assistant collect information of the certain patient or the medical records available to the physician while protecting the patients privacy.

A model can be built for the patient to look up the most likely diagnosis for the patient and provide to the physicians and also look up through the internet or the medical literature and research literature. Based on the patient data, including the user data and medical records, the AI assistant can come up with the best diagnosis and also building a computer simulation model of the patient's information including a weight, blood pressure, blood composition, blood work, genetics, genetic information, that dietary habit including the recorded user, data from the patients either daily survey or daily record and also including data. From the patients who and the patient's urine, including chemical analysis, using the simulation to build a realistic whole body modeling of the patient through the modeling not only. Probable diagnosis can be provided to the physician. Also, medical literature research can be provided, including the most likely diagnosis and the best treatment strategy. Then the physician can prescribe prescription drugs for the. Patient but before patient or prescribed the drugs, the drugs is input into the realistic simulation of the whole patient body going through all the physical and chemical processes inside the simulated physics, the patient's body including. The genetic information specific to the patients and then simulate all the possible outcome including therapeutic effect and side effects and provided to the physician and the patient for reference. Right me patiently application based on the above.

The AI-assisted physician assistant system can be designed to enhance medical diagnosis and treatment planning. By integrating patient data, medical literature, and computer simulations, the system provides physicians with accurate diagnoses, treatment strategies, and potential outcomes. The AI system ensures patient privacy while improving healthcare decision-making.

Medical professionals face challenges in diagnosing complex cases and selecting optimal treatments. Existing solutions lack real-time integration of patient data, medical research, and personalized simulations.

Data Collection and Privacy Protection: the system collects patient data, including medical records and user information.

Ensures privacy compliance by anonymizing and securely storing patient data.

Accessible through mobile terminals or cloud-based platforms.

AI Diagnosis and Literature Research: AI model analyzes patient data to generate probable diagnoses.

Searches medical literature and research databases for relevant information.

Provides physicians with evidence-based insights.

Computer Simulation Modeling: Constructs a whole-body simulation model for each patient.

Includes weight, blood pressure, blood composition, genetics, dietary habits, and daily survey data.

Simulates physical and chemical processes within the patient's body.

Treatment Strategy and Outcome Prediction: Recommends the best treatment strategy based on diagnosis and literature.

Integrates genetic information for personalized medicine.

Simulates therapeutic effects and potential side effects.

Provides physicians and patients with outcome scenarios.

A system for assisting physicians in medical diagnosis and treatment planning, including: an AI model for analyzing patient data and generating probable diagnoses.

A medical literature research component for evidence-based insights.

A computer simulation module for constructing whole-body models and predicting treatment outcomes.

Wherein patient privacy is protected through anonymization and secure data storage.

The system further includes a user-friendly interface accessible via mobile terminals or cloud platforms.

The treatment strategies consider genetic information and personalized factors.

The AI-assisted physician assistant system revolutionizes healthcare by combining data-driven diagnosis, literature research, and personalized simulations. By empowering physicians with accurate information, the invention improves patient outcomes and ensures privacy compliance.

The main components and functions of the AI-assisted physician assistant system for medical diagnosis and treatment planning may include the following components: the patient data, the medical literature, the computer simulations, and the AI system. The system performs three main functions: diagnosis, treatment, and outcome.

The patient data can be the data that contain the medical history, symptoms, test results, and other relevant information of the patient. The patient data is collected and stored securely by the AI system.

The medical literature can be the literature that contains the scientific research, clinical trials, guidelines, and best practices of the medical field. The medical literature is accessed and analyzed by the AI system.

The computer simulations are the simulations that model the physiological and pathological processes of the patient's body and the effects of the treatment options. The computer simulations are created and run by the AI system.

The AI system can be the system that integrates the patient data, the medical literature, and the computer simulations to provide the physicians with accurate diagnoses, treatment strategies, and potential outcomes. The AI system uses natural language processing, machine learning, and deep learning techniques to perform the functions. The AI system also ensures patient privacy while improving healthcare decision-making.

The diagnosis function can be the process of identifying and explaining the medical condition of the patient based on the patient data and the medical literature by the AI system.

The treatment function is the process of recommending and planning the best treatment option for the patient based on the diagnosis, the patient data, the medical literature, and the computer simulations by the AI system.

The outcome function can be the process of predicting and evaluating the expected outcome of the treatment for the patient based on the treatment, the patient data, the medical literature, and the computer simulations by the AI system.

The AI system can include a computer device that performs the functions of the AI-assisted physician assistant system for medical diagnosis and treatment planning. The system has a processor, a memory, a storage, a network interface, and a user interface.

The processor can include a device that executes the instructions and algorithms of the AI system. The processor uses natural language processing, machine learning, and deep learning techniques to perform the diagnosis, treatment, and outcome functions.

The memory is a device that stores the temporary data and information of the AI system. The memory holds the patient data, the medical literature, and the computer simulations while the processor performs the functions.

The storage is a device that stores the permanent data and information of the AI system. The storage saves the patient data, the medical literature, and the computer simulations for future use and reference.

The network interface is a device that connects the AI system to the internet and other devices. The network interface enables the AI system to access and analyze the medical literature, as well as to communicate and share the results with the physicians and other systems.

The user interface is a device that provides the input and output of the AI system. The user interface allows the AI system to receive the patient data and the physician's queries, as well as to display the diagnosis, treatment, and outcome results.

In another aspect, the AI assist methods and systems are associated with the content generation and distribution described above. For example, a user/patient can dial in a number or enter a chat APP to discuss a medical condition and/or heal concern. The server/cloud generates AI-based answers to the user, and further automatically directs the user to an actual physician in a network based on parameters including expertise, availability, etc. The actual physician, once connected, e.g., during their spare time or during actual work hours as they so choose, answers the user, vet the answers generated by the AI, and/or provide prescriptions as allowed by law, thereby achieving an organic integration between AI assistant and actual physical physicians.

In another aspect, the content organization involves a computer-based voting system and method and apparatus. Traditionally, voting is done on paper ballots or localized voting machines and the voters are disconnected. From the outcome in this new voting system and the methods of voter voting are through the internet, a cloud server and the results are automatically linked to the individual. Users voting results. For example, if a voter votes for a certain war, the voter will automatically be entered for drafting to be recruited for the war itself if a voter vote. More certain education system, parts of the voters tax dollars are automatically added as you allocated to the voting to the education facility methods of curriculum if a voter. Votes for certain environmental measures. The voters voting result will be correlated to his tax contributions to the environmental measures. This way voters interest will be. More directly linked to the outcome, the money, and, as even their life devoted to such a voting outcome. Traditionally, the many voters vote by party lines with fixed parties. In this inventive voting system and methods, the voters do not vote for certain parties, rather the voters. What will be based on policies and the certain policies automatically group together and form certain policy based new parties. These parties are dynamic, dynamic parties. And evolve based on the society needs.

A computer-based voting system and method are disclosed, revolutionizing the traditional voting process. Unlike paper ballots or localized voting machines, this innovative system leverages the internet, cloud servers, and individualized results.

Individualized Voting: Voters cast their ballots online, securely connected to a cloud-based server. Each vote is uniquely linked to the individual voter.

Outcome Correlation: War Voting: If a voter supports a particular war, their vote automatically enters them into a draft pool for recruitment.

Education Funding: When a voter supports specific education policies, a portion of their tax dollars is allocated directly to the corresponding curriculum.

Environmental Measures: Voting for environmental initiatives correlates with the voter's tax contributions to environmental programs.

Dynamic Parties: Instead of fixed party lines, voters base their choices on policies. These policy-based parties dynamically evolve to address society's changing needs.

Individualized Voting: Voters access the system via a secure online portal.

Each voter receives a unique computer-readable code via mail, ensuring identity confirmation.

Voters select their choices, and an electronic signature confirms their ballot information.

The system separates voter identification from votes to maintain anonymity.

Votes are stored on a distributed ledger using blockchain technology.

### Outcome Correlation

War Voting: If a voter supports a war, their vote triggers automatic entry into a draft pool. This ensures that those advocating for war are directly impacted by its consequences.

Education Funding: Votes for education policies directly allocate tax dollars to relevant curriculum areas. The more a voter supports education, the greater their contribution to educational programs.

Environmental Measures: Environmental votes correlate with the voter's tax contributions to environmental initiatives. This aligns personal interests with funding for environmental protection.

Dynamic Parties: Voters no longer adhere to fixed party affiliations. Instead, they align with policy-based parties that evolve based on societal needs. These dynamic parties adapt to changing circumstances, fostering a more responsive political landscape.

The computer-based voting system and method enhance voter engagement, transparency, and accountability. By linking individual actions to outcomes, citizens become active participants in shaping their society. This invention represents a significant leap toward a more informed and impactful democratic process.

In another aspect, a computer-based system, methods and network as well as devices can be configured to curb firearm-related violence. This system automatically monitor misdemeanor violations such as simple traffic violations, then automatically enter such a vehicle users. Database into a database of prohibiting these users to have to own firearms because typical gun violence are related from. Either those who disregarded the law or rules are who are absent minded and this characters are highly correlated with the driving behaviors. So based on driving. Behaviors. The database can be created to automatically prevent certain groups of the society to own firearms. There is little legal basis to this too, because they have. Broken the law, even though traffic law in the first place. By doing so, it is projected that gun violence can be reduced by at least 50% and so is traffic. Death would also be reduced by at least 50%, saving 10s of billions dollars of to the society. As well as thousands of lives.

By monitoring misdemeanor violations, particularly traffic violations, and correlating them with driving behaviors, this system aims to prevent certain individuals from owning firearms. The proposed system has the potential to significantly reduce gun violence and traffic-related deaths, resulting in substantial societal benefits.

Gun violence is a pressing issue in society, and innovative solutions are needed to address it effectively. The computer-based system leverages data-driven approaches to enhance public safety and prevent firearm-related incidents.

Monitoring Misdemeanor Violations: The system continuously monitors misdemeanor violations, with a focus on traffic-related offenses. Violations such as reckless driving, speeding, or running red lights are automatically recorded and linked to individual users.

Database Creation: The system maintains a centralized database of users who have committed misdemeanor violations. These users are flagged as ineligible to own firearms based on their disregard for traffic laws.

Correlation with Driving Behaviors: Research indicates a strong correlation between certain driving behaviors and propensity for violence.

Users who exhibit absent-mindedness, impulsivity, or disregard for rules are at higher risk for gun-related incidents.

Legal Basis: While traffic violations may seem unrelated to gun ownership, they serve as an indicator of behavioral tendencies. Existing legal frameworks allow for restricting firearm ownership based on behavioral risk factors.

Projected Impact: By preventing certain groups from owning firearms, the system aims to reduce gun violence by at least 50%. Simultaneously, traffic-related deaths are expected to decrease by a similar percentage. These reductions translate to significant cost savings and thousands of lives saved.

By leveraging existing legal mechanisms and correlating misdemeanor violations with driving behaviors, we can create a safer society for all. This invention has the potential to save lives, reduce healthcare costs, and enhance public safety.

The system may include the following components: the traffic monitoring device, the cloud server, the firearm database, and the firearm control device. The system performs four main functions: traffic violation detection, driving behavior analysis, firearm ownership evaluation, and firearm access restriction.

The traffic monitoring device is a device installed in the vehicle that records and transmits traffic violations, such as speeding, running red lights, or driving under the influence, to the cloud server.

The cloud server is a platform that receives and processes the traffic violation data from the traffic monitoring device. The server also performs driving behavior analysis, which is a function that uses machine learning algorithms to identify patterns and trends in the driving behavior of the vehicle owner, such as aggressiveness, recklessness, or impulsiveness.

The firearm database is a database that stores and updates the firearm ownership information of the vehicle owner, such as the type, model, serial number, and location of the firearm, as well as the license and registration status of the firearm owner.

The firearm control device is a device attached to the firearm that controls the access and operation of the firearm. The device communicates with the cloud server and receives commands to lock or unlock the firearm based on the firearm ownership evaluation.

The firearm ownership evaluation is a function that determines the eligibility and suitability of the vehicle owner to own and use a firearm. The evaluation is based on the traffic violation data, the driving behavior analysis, and the firearm ownership information. The evaluation uses a scoring system that assigns points to different factors, such as the frequency, severity, and recency of the traffic violations, the level of risk and danger of the driving behavior, and the compliance and responsibility of the firearm ownership. The evaluation also considers the legal and ethical implications of the firearm ownership, such as the background check, the mental health assessment, and the social impact of the firearm use. The evaluation generates a score that indicates the likelihood of the vehicle owner to cause or be involved in gun violence. The score is compared to a threshold value that determines the firearm access restriction.

The firearm access restriction is a function that controls the access and operation of the firearm based on the firearm ownership evaluation. The function sends commands to the firearm control device to lock or unlock the firearm. The function also sends notifications and alerts to the vehicle owner, the firearm owner, the law enforcement agencies, and the firearm dealers about the firearm access restriction status and the reasons for the restriction.

The method can include the following steps: traffic violation detection, driving behavior analysis, firearm ownership evaluation, firearm access restriction, notification and alert, and feedback and update.

The traffic violation detection step is the process of recording and transmitting traffic violations from the traffic monitoring device to the cloud server.

The driving behavior analysis step is the process of identifying patterns and trends in the driving behavior of the vehicle owner using machine learning algorithms on the cloud server.

The firearm ownership evaluation step is the process of determining the eligibility and suitability of the vehicle owner to own and use a firearm based on the traffic violation data, the driving behavior analysis, and the firearm ownership information on the cloud server.

The firearm access restriction step is the process of controlling the access and operation of the firearm based on the firearm ownership evaluation on the cloud server.

The notification and alert step is the process of sending notifications and alerts to the vehicle owner, the firearm owner, the law enforcement agencies, and the firearm dealers about the firearm access restriction status and the reasons for the restriction on the cloud server.

The feedback and update step is the process of receiving feedback and updating the traffic violation data, the driving behavior analysis, the firearm ownership information, and the firearm access restriction status on the cloud server.

This diagram shows a line drawing of the traffic monitoring device. The device is a small box that is installed in the vehicle, preferably in a hidden or inconspicuous location. The device has a camera, a microphone, a GPS, a wireless transmitter, and a power source. The device uses the camera and the microphone to capture and record traffic violations, such as speeding, running red lights, or driving under the influence. The device uses the GPS to track and record the location and speed of the vehicle. The device uses the wireless transmitter to send the traffic violation data to the cloud server. The device uses the power source to operate and function.

The device is a small lock that is attached to the firearm, preferably in a position that prevents the trigger from being pulled. The device has a wireless receiver, a locking mechanism, and a power source. The device uses the wireless receiver to communicate with the cloud server and receive commands to lock or unlock the firearm. The device uses the locking mechanism to physically block or allow the access and operation of the firearm. The device uses the power source to operate and function.

The system according to some embodiments can include four main components: the behavior monitoring device, the cloud server, the dangerous device database, and the dangerous device control device. The system performs four main functions: behavior detection, behavior analysis, device ownership evaluation, and device access restriction.

The behavior monitoring device is a device installed in the vehicle that records and transmits behavior data, such as speed, acceleration, braking, steering, and lane changing, to the cloud server. The device also receives commands from the cloud server to control the vehicle.

The cloud server is a platform that receives and processes the behavior data from the behavior monitoring device. The server also performs behavior analysis, which is a function that uses machine learning algorithms to identify and classify severe behaviors of the vehicle owner, such as speeding, aggressive maneuvers, tailgating, or weaving. The server also performs device ownership evaluation, which is a function that determines the eligibility and suitability of the vehicle owner to own and use a dangerous device, such as a firearm, a knife, or an explosive.

The dangerous device database is a database that stores and updates the dangerous device ownership information of the vehicle owner, such as the type, model, serial number, and location of the device, as well as the license and registration status of the device owner.

The dangerous device control device is a device attached to the dangerous device that controls the access and operation of the device. The device communicates with the cloud server and receives commands to lock or unlock the device based on the device ownership evaluation.

The behavior detection function is the process of recording and transmitting behavior data from the behavior monitoring device to the cloud server.

The behavior analysis function is the process of identifying and classifying severe behaviors of the vehicle owner using machine learning algorithms on the cloud server.

The device ownership evaluation function is the process of determining the eligibility and suitability of the vehicle owner to own and use a dangerous device based on the behavior data, the behavior analysis, and the dangerous device ownership information on the cloud server.

The device access restriction function is the process of controlling the access and operation of the dangerous device based on the device ownership evaluation on the cloud server.

This diagram shows the main steps and logic of the computer-based method for certain behaviors. The method consists of six main steps: behavior detection, behavior analysis, device ownership evaluation, device access restriction, notification and alert, and feedback and update.

The behavior detection step is the process of recording and transmitting behavior data from the behavior monitoring device to the cloud server.

The behavior analysis step is the process of identifying and classifying severe behaviors of the vehicle owner using machine learning algorithms on the cloud server.

The device ownership evaluation step is the process of determining the eligibility and suitability of the vehicle owner to own and use a dangerous device based on the behavior data, the behavior analysis, and the dangerous device ownership information on the cloud server.

The device access restriction step is the process of controlling the access and operation of the dangerous device based on the device ownership evaluation on the cloud server.

The notification and alert step is the process of sending notifications and alerts to the vehicle owner, the device owner, the law enforcement agencies, and the device dealers about the device access restriction status and the reasons for the restriction on the cloud server.

The feedback and update step is the process of receiving feedback and updating the behavior data, the behavior analysis, the device ownership information, and the device access restriction status on the cloud server.

The device is can be small box that is installed in the vehicle, preferably in a hidden or inconspicuous location. The device has a sensor, a wireless transmitter, and a power source. The device uses the sensor to collect and record behavior data, such as speed, acceleration, braking, steering, and lane changing. The device uses the wireless transmitter to send the behavior data to the cloud server. The device also receives commands from the cloud server to control the vehicle. The device uses the power source to operate and function.

The device can be a small lock that is attached to the dangerous device, preferably in a position that prevents the operation of the device. The device has a wireless receiver, a locking mechanism, and a power source. The device uses the wireless receiver to communicate with the cloud server and receive commands to lock or unlock the device. The device uses the locking mechanism to physically block or allow the access and operation of the device. The device uses the power source to operate and function.

In some other implementations, rather than using a lock, the law enforcement can be informed and authorized to reject the individual's firearm applications, black list gun sales, or even conduct search warrants to remove the dangerous devices from the dangerous individuals.

In another aspect, an automatic system and computer devices on a vehicle or mobile phone based device are provided to automatically queue the driver or the autopilot of the vehicle to identify dangerous. Behaviors of other vehicles nearby, including larger vehicles such as trucks, and dangerous driving behaviors such as speeding, such as swearing among traffic, such as roads drivers who keep a much smaller. With distance compared with other drivers. Once this drivers and driving behaviors are identified, then automatically kill the driver or the Autopilot of this vehicle to keep a much larger safety distance compared with the regular distance based on the above.

An automatic system and computer devices can be installed in vehicles or mobile-based devices. This system aims to enhance driver safety by identifying dangerous behaviors of nearby vehicles, including larger vehicles such as trucks. By monitoring driving behaviors such as speeding and aggressive maneuvers, the system automatically adjusts the vehicle's following distance to maintain a safer buffer zone. This method has the potential to significantly reduce accidents and improve road safety.

Driving safety is a critical concern, especially in congested traffic or when sharing the road with larger vehicles. The proposed automatic system leverages advanced technology to mitigate risks associated with dangerous driving behaviors.

### System Components

Sensors: The system utilizes onboard sensors (such as cameras, radar, lidar) to monitor nearby vehicles.

Processing Unit: A powerful onboard computer processes sensor data in real-time.

Algorithms: Proprietary algorithms analyze driving behaviors and assess risk levels.

### Identifying Dangerous Behaviors

Speeding: The system detects vehicles exceeding speed limits or driving significantly faster than surrounding traffic.

Aggressive Maneuvers: Sudden lane changes, tailgating, and abrupt braking are flagged as risky behaviors.

Swearing Among Traffic: Audio sensors identify aggressive language or road rage incidents.

### Automatic Safety Adjustments

Following Distance: When dangerous behaviors are detected, the system automatically adjusts the vehicle's following distance.

Regular Distance: Maintains a safe distance based on traffic conditions.

Enhanced Safety Distance: Increases the buffer zone to minimize collision risks.

### Autopilot Integration

For vehicles equipped with autopilot features, the system communicates directly with the autopilot.

If the driver fails to respond to warnings or corrective prompts, the autopilot intervenes to maintain safety.

### Legal Considerations

The system operates within existing traffic laws and regulations.

It does not override driver control but enhances safety by providing real-time feedback.

The proposed automatic system represents a significant advancement in road safety technology. By identifying dangerous behaviors and adjusting following distances, it contributes to accident prevention and overall driver well-being.

In some embodiments, components and functions of the automatic system for enhancing vehicle safety are provided for preventing dangerous driving behaviors. The system can include four main components: the vehicle device, the mobile device, the cloud server, and the vehicle control system. The system performs four main functions: driving behavior monitoring, driving behavior analysis, following distance adjustment, and vehicle control.

The vehicle device is a device installed in the vehicle that collects and transmits driving behavior data, such as speed, acceleration, braking, steering, and lane changing, to the mobile device and the cloud server. The device also receives commands from the mobile device and the cloud server to control the vehicle.

The mobile device is a device carried by the driver that communicates with the vehicle device and the cloud server. The device also provides a user interface for the driver to access and manage the system settings and preferences.

The cloud server is a platform that receives and processes the driving behavior data from the vehicle device and the mobile device. The server also performs driving behavior analysis, which is a function that uses machine learning algorithms to identify and classify dangerous driving behaviors of nearby vehicles, such as speeding, aggressive maneuvers, tailgating, or weaving. The server also performs following distance adjustment, which is a function that calculates and recommends the optimal following distance for the vehicle based on the driving behavior analysis and the road conditions.

The vehicle control system is a system that controls the vehicle's speed, braking, and steering based on the commands from the vehicle device and the cloud server. The system also provides feedback and alerts to the driver about the vehicle's status and performance.

The driving behavior monitoring function is the process of collecting and transmitting driving behavior data from the vehicle device to the mobile device and the cloud server.

The driving behavior analysis function is the process of identifying and classifying dangerous driving behaviors of nearby vehicles using machine learning algorithms on the cloud server.

The following distance adjustment function is the process of calculating and recommending the optimal following distance for the vehicle based on the driving behavior analysis and the road conditions on the cloud server.

The vehicle control function is the process of controlling the vehicle's speed, braking, and steering based on the commands from the vehicle device and the cloud server.

The method can include six main steps: driving behavior monitoring, driving behavior analysis, following distance adjustment, vehicle control, feedback and alert, and user interface.

The driving behavior monitoring step is the process of collecting and transmitting driving behavior data from the vehicle device to the mobile device and the cloud server.

The driving behavior analysis step is the process of identifying and classifying dangerous driving behaviors of nearby vehicles using machine learning algorithms on the cloud server.

The following distance adjustment step is the process of calculating and recommending the optimal following distance for the vehicle based on the driving behavior analysis and the road conditions on the cloud server.

The vehicle control step is the process of controlling the vehicle's speed, braking, and steering based on the commands from the vehicle device and the cloud server.

The feedback and alert step is the process of providing feedback and alerts to the driver about the vehicle's status and performance from the vehicle control system.

The user interface step is the process of accessing and managing the system settings and preferences from the mobile device.

The device is a small box that is installed in the vehicle, preferably in a hidden or inconspicuous location. The device has a sensor, a wireless transmitter, and a power source. The device uses the sensor to collect and record driving behavior data, such as speed, acceleration, braking, steering, and lane changing. The device uses the wireless transmitter to send the driving behavior data to the mobile device and the cloud server. The device also receives commands from the mobile device and the cloud server to control the vehicle. The device uses the power source to operate and function.

In another aspect, a simulation-based optimization method can be applied to certain job positions training and selection.

For example, one of the airline transport pilot (ATP) requirements was increased to be a minimum of 1500 flying hours in response to public's panic over one accident.

In response to such requirements, many pilots simply fly straight and level using the cheapest aircraft to achieve such minimum hours, while gaining little or no experience that can help reducing probability of future accidents.

Various embodiments of the present disclosure provide a training/selection system, where a certain job position (e.g., ATP) requires a candidate to go through a first predetermined milestone (e.g., 200 hours) of training/evaluation on a simulator, rather than a minimum (e.g., 1500 hours) of actual flying “experience.”

In some embodiments, the simulator training/evaluation emulates real-life situations of airline pilots. For example, the candidates can be on call for certain duty hours, including day, night, short-haul, long-haul, all-weather flight simulations, and randomized failure/emergency scenarios during the simulator sessions.

The candidates are automatically scored during such simulator sessions. If they fail a critical task, or a certain number of less-critical tasks, they will be required to restart the 200-hour evaluation session, or leave the profession all together.

In another aspect, a simulation-based optimization system and method involve constructing individualized model for a patient, including biological, genetic, chemical parameters. A medicine/food supplement will be simulated on the patient's model, to find out potential outcomes, including therapeutic effects and side effects, before the medicine/food supplement is given to the specific patient.

In another aspect, a simulation-based optimization method, is applied to a patent drafting, examination, and litigation process, where the patent draft is first simulated through various stages of searches, invalidity, and other courses, before a significant investment on the patent application is committed.

The method of simulating a process for drafting a patent application includes: searching uncopyrighted literature for references related to an invention disclosure or a draft claim; rewriting content from the references to be embodiments or variations of the invention disclosure or the draft claim; iterating said searching the uncopyrighted literature and said rewriting the content to expand the rewritten content; generating a plurality of draft patent applications based on the rewritten content from a plurality of subsets of the references; selecting an optimal one of the plurality of draft patent applications to be the patent application based on at least one of a patent examination simulation or a patent litigation simulation; wherein the patent examination simulation includes: searching prior art related to the plurality of draft patent applications; and selecting one or more of the draft patent applications based on simulated allowance probabilities based on the searched prior art; and wherein the patent litigation simulation includes: searching case laws related to the one or more of the plurality of draft patent applications; searching product related to the one or more of the plurality of draft patent applications; simulating infringement probabilities based on the searched product; simulating invalidity proceedings and infringement findings in a number of court systems; and selecting an optimized patent application based on likelihood of winning the invalidity proceedings and infringement findings.

In another aspect, an investment is simulated in a model of market, including individual and institution investors represented by “carriers” in a Monte Carlo model, where the simulated investment is run through all sorts of possibilities, based on probability equations, to generate simulated returns in various possible scenarios for an investor to consider.

In another aspect, traffic is simulated based on probabilities of various driving scenarios in a Monte Carlo model, and a driver or autopilot is advised of all possible routes and actions based on probabilities, and provide best action items for highest probabilities to achieve the driver or autopilot's objectives.

In some embodiments, a periscope is provided on a vehicle, which can extend when there are no obstacles, and can take videos of real-time nearby traffic, to advise the driver or autopilot to change lanes to achieve an optimal goal.

In another aspect, a bird strike prevention system is provided for wind turbines that automatically emits a sound to scare birds away during turbine operation. The system utilizes aerodynamics and turbine motion to trigger the sound generation. When the turbine spins, a mechanical whistle produces a bird-repelling sound, such as mimicking hawk calls. The sound ceases when the turbine stops, creating a protective buffer zone around the turbine blades.

Bird collisions with wind turbines pose risks to avian populations and turbine efficiency. Existing solutions include visual deterrents (e.g., reflective tape) but lack effectiveness. The proposed system aims to enhance bird safety while minimizing turbine downtime.

Mechanical Whistle Mechanism: A mechanical device integrated into the turbine structure.

Activated by turbine rotation: generates a high-frequency sound (e.g., hawk screech) to deter birds, with adjustable pitch and volume settings.

Electronic Control Unit (ECU): Monitors turbine motion.

Triggers the whistle when the turbine spins.

Stops the sound when the turbine halts.

Powered by the turbine's electrical system.

Sound Generation: whistle design based on aerodynamic principles.

Simulates natural bird predator sounds.

Ensures audibility within a safe range for humans.

Buffer Zone Creation: sound radius calibrated to prevent bird entry into the turbine area.

Birds perceive the sound as a threat and avoid the vicinity.

Enhances bird safety without affecting turbine performance.

A bird strike prevention system for wind turbines can include the following components.

A mechanical whistle integrated into the turbine structure.

An ECU connected to the whistle and turbine motion sensors.

The whistle generating a bird-repelling sound during turbine rotation.

The sound ceasing when the turbine stops.

Wherein the whistle sound mimics hawk calls.

The system further comprising adjustable pitch and volume settings.

Wherein the sound radius creates a protective buffer zone around the turbine blades.

The bird strike prevention system combines mechanical and electronic components to enhance bird safety near wind turbines. By emitting a deterrent sound during turbine operation, the system minimizes bird collisions without compromising turbine efficiency.

The apparatus may prevent birds striking wind turbines. When the wind turbines spins, a whistle automatically comes out to scare the birds away. The whistle can be a mechanical device that automatically generates. A scary sound for the birds based on aerodynamics and such as the air flow through the turbine keeps in another verification or embodiment. The whistle sound is generated electronically, for example. Based on the motion of the turbine and the simulate the scary or sound for other like hawks sound to scare the birds away and when the turbine stops the sound stops too so that way. The sound would create a buffer zone to prevent the birds flying into the turbines and being killed.

This diagram shows the main components and functions of the bird strike prevention system for wind turbines. The system consists of two main components: the mechanical whistle and the turbine blade. The system performs one main function: sound generation.

The mechanical whistle is a device attached to the turbine blade that produces a bird-repelling sound, such as mimicking hawk calls, when the turbine spins. The whistle is powered by the airflow and the centrifugal force generated by the turbine motion.

The turbine blade is a part of the wind turbine that rotates and converts wind energy into mechanical energy. The blade also supports and activates the mechanical whistle.

The sound generation function is the process of emitting a sound to scare birds away during turbine operation. The function is triggered by the turbine motion and the aerodynamics. The function stops when the turbine stops, creating a protective buffer zone around the turbine blades.

This diagram shows a line drawing of the mechanical whistle. The whistle is a small cylinder that is attached to the turbine blade, preferably near the tip. The whistle has a nozzle, a chamber, a reed, and a sound hole. The whistle works as follows:

The nozzle is an opening that directs the airflow into the chamber. The nozzle is angled to create a Venturi effect, which increases the airflow velocity and decreases the air pressure inside the chamber.

The chamber is a hollow space that contains the reed and the sound hole. The chamber resonates and amplifies the sound produced by the reed.

The reed is a thin piece of metal that vibrates when the airflow passes through it. The reed produces a sound that mimics hawk calls, which repels birds. The reed also acts as a valve that controls the airflow and the sound frequency.

The sound hole is an opening that releases the sound from the chamber to the outside. The sound hole is located on the opposite side of the nozzle, facing away from the turbine blade.

In another aspect, an automatic optical device shutter system is provided to prevent long exposure streaks caused by satellites and aircraft during astronomical observations. By utilizing existing satellite and aircraft tracking databases, the system adjusts the optical correction or electronically filters out streaks from celestial objects. The system can either shut down the shutter or employ a blocking device to maintain optical data integrity and preserve astronomical research.

Long exposure photography in astronomy is essential for capturing detailed images of celestial objects. However, satellite and aircraft movements can create undesirable streaks in these exposures. Existing solutions lack automation and real-time adaptation to changing conditions.

Satellite and Aircraft Tracking Database: utilizes existing databases with satellite and aircraft tracks based on times and locations.

Predicts satellite and aircraft passes in front of telescopes, cameras, and lenses.

Updates the database based on the telescope's location and orientation.

Automatic Shutter Control: when a satellite or aircraft pass is imminent, the system: temporarily shuts down the shutter to prevent streaks; activates a blocking device to obstruct the field of view; and restores normal operation after the pass.

Adaptive Optical Correction: Adjusts optical or electronic settings to filter out streaks during long exposures. Corrects for satellite and aircraft motion. Ensures optimal image quality for astronomical research.

Aircraft Tracking: Uses ADS-B signals or FAA dynamic databases to track commercial airliners. Temporarily shuts down the shutter or activates the blocking device during scheduled flights. A system for preventing long exposure streaks caused by satellites and aircraft during astronomical observations, including: a satellite and aircraft tracking database; an automatic shutter control mechanism; an adaptive optical correction system; an aircraft tracking using ADS-B signals or FAA databases; wherein the automatic shutter control temporarily shuts down the shutter or activates a blocking device; wherein the adaptive optical correction adjusts optical or electronic settings during long exposures.

The system further includes a user interface for manual override.

The automatic optical device shutter system enhances astronomical research by minimizing streaks caused by satellites and aircraft. By preserving data integrity and dark skies, the invention contributes to the advancement of celestial observation.

Concerning automatic optical device shutters such as telescope cameras, binoculars, etc. In areas such as in astronomy we take when taking long exposures of the night skies. The satellites such as Star link satellites would cause long strict lines through the long exposure ruining the images being exposed, especially in astronomy sometimes when hours long. Exposure are desired to image or taking spectroscopy of remote celestial extraterrestrial objects such as quasars and galaxies. This invention based use existing. Databases of all the satellite tracks based on times and locations and the forecast predicted passing through times in front of the telescope and cameras and lenses and automatically either shut down the shutter. Or using a small blocking device to block the satellite from the field of view. For the long exposure, the database will be adjusted or adapted following the location of the telescope. The orientation or the pointing angle of the telescope to a time automatically makes the optical correction or electronic correction to automatically filter out the long streaks of the exposure from the celestial objects such as. Satellites and also airplanes as their lights can ruin the exposure for astronomical research too. Most of the airplanes, especially commercial airliners have fixed the schedules and also they are tractable. So in this sense even though. There's not a fixed database such as satellites. The software and computer systems or app can automatically track the locations from the airplanes, such as using ADSB signals or FAA dynamic databases and. Likely either temporarily shut down the shutters of the telescope or using blocking device to block them from the field of view, thereby improving optical data integrity and preserving the research for the astronomy. Preserving darker skies.

This diagram shows the main components and functions of the automatic optical device shutter system for satellite and aircraft avoidance. The system consists of four main components: the optical device, the satellite and aircraft tracking database, the optical correction and filtering module, and the shutter and blocking device. The system performs three main functions: satellite and aircraft detection, optical correction and filtering, and shutter and blocking control.

The optical device is a device that captures and records astronomical images, such as a telescope, a camera, or a spectrometer. The device has a lens, a sensor, and a shutter. The device also communicates with the satellite and aircraft tracking database and the optical correction and filtering module.

The satellite and aircraft tracking database is a database that stores and updates the location and trajectory of satellites and aircraft in the sky. The database also communicates with the optical device and the optical correction and filtering module.

The optical correction and filtering module is a module that adjusts the optical device settings or electronically filters out the streaks caused by satellites and aircraft from the astronomical images. The module communicates with the optical device, the satellite and aircraft tracking database, and the shutter and blocking device.

The shutter and blocking device is a device that controls the shutter or employs a blocking device to prevent the exposure of the optical device sensor to the satellites and aircraft. The device communicates with the optical correction and filtering module.

The satellite and aircraft detection function is the process of detecting and locating satellites and aircraft in the sky using the satellite and aircraft tracking database and the optical device sensor.

The optical correction and filtering function is the process of adjusting the optical device settings or electronically filtering out the streaks caused by satellites and aircraft from the astronomical images using the optical correction and filtering module.

The shutter and blocking control function is the process of controlling the shutter or employing a blocking device to prevent the exposure of the optical device sensor to the satellites and aircraft using the shutter and blocking device.

This diagram shows a line drawing of the optical device. The device is a telescope that captures and records astronomical images. The device has a lens, a sensor, and a shutter. The device also has a wireless transmitter and a power source. The device works as follows:

The lens is a curved glass or plastic piece that focuses the light from the astronomical objects onto the sensor. The lens can be adjusted to change the magnification and the field of view of the device.

The sensor is a device that converts the light into electrical signals that form the astronomical images. The sensor can be a charge-coupled device (CCD) or a complementary metal-oxide-semiconductor (CMOS) device. The sensor can also be adjusted to change the exposure time and the sensitivity of the device.

The shutter is a device that controls the amount of light that reaches the sensor. The shutter can be opened or closed to start or stop the exposure of the sensor. The shutter can also be adjusted to change the duration and the frequency of the exposure of the sensor.

The wireless transmitter is a device that communicates with the satellite and aircraft tracking database and the optical correction and filtering module. The transmitter sends and receives data and commands to and from the database and the module.

The power source is a device that provides the energy for the operation and function of the device. The power source can be a battery, a solar panel, or a generator.

In another aspect, an automatic dog leash is provided. When users are walking a dog on the leash, sometimes the dog can rush to another dog and run away and the southern force exerted on the dog walker. Can sometimes injure dog walker. This new invention has automatic adaptive force. For example, when the dog attempted to run really fast, the device automatically releases or in our lengthen. The dog leash, slowly with the dampened force that is sufficient for the dog walker to handle, and if the dog is walking slowly then the force will be smaller, allowing the dog to roam freely. So that way the automatic device can adaptively adapt the force exerted on the dog worker. An analogy in one embodiment is a dog leash device has a real and a belt. Similar to a seat belt in the vehicle that automatically adjust the force based on the how fast it is being released and the force and provide the feedback automatically in some other embodiments. A processor or processing circuit is provided at electronically adjust the force released through the dog leashes, that is make it predictable to the dog walker and not exerting too much force and while giving. Prescribed the freedom to the dog itself, as it's adaptive in the sense that it automatically adjusts based on the force on the speed on the direction. The bottom line is to prevent a sudden jerky force on the. A person to avoid the person being dragged down by the dog.

### Automatic Adaptive Force Dog Leash System

The disclosure pertains to an automatic adaptive force dog leash system designed to enhance safety and comfort during dog walks. By adjusting the leash tension based on the dog's speed and behavior, the system prevents sudden jerky forces on the dog walker. The adaptive force ensures both dog freedom and handler control.

Traditional dog leashes lack adaptability, leading to sudden pulls and potential injuries. The proposed system aims to provide a dynamic leash tension that accommodates varying dog behaviors.

Automatic Adaptive Force Mechanism: The leash automatically adjusts tension based on the dog's movement. When the dog runs fast, the leash releases or lengthens gradually. Slow dog walking results in reduced leash force.

Dampened Force Feedback: The leash provides dampened feedback to the dog walker. Sufficient force for control without sudden jerks. Prevents injuries to the handler.

Belt and Reel Design: Analogous to a seat belt in a vehicle. A reel mechanism adjusts leash length. Belt material ensures durability and comfort.

Electronic Force Adjustment: a processor or processing circuit monitors dog speed and direction. Electronically adjusts leash tension. Predictable force for the dog walker.

A dog leash system with automatic adaptive force includes: a reel mechanism for adjusting leash length; an electronic processor for monitoring dog behavior; a dampened force feedback system; a belt design for durability and comfort; wherein leash tension adapts based on dog speed.

The system further includes a user-friendly interface for manual override.

The adaptive force prevents sudden jerky forces on the dog walker.

The automatic adaptive force dog leash system revolutionizes dog walking by ensuring safety, comfort, and handler control. By dynamically adjusting leash tension, the invention enhances the dog-walking experience for both pets and their owners.

This diagram shows the main components and functions of the automatic adaptive force dog leash system for dog walks. The system consists of three main components: the dog collar, the leash, and the handle. The system performs two main functions: leash tension adjustment and force feedback.

The dog collar is a device that attaches to the dog's neck and measures the dog's speed and behavior, such as running, stopping, or pulling. The collar also communicates with the leash and the handle.

The leash is a device that connects the dog collar and the handle and adjusts the leash tension based on the dog's speed and behavior. The leash also communicates with the collar and the handle.

The handle is a device that holds the leash and provides force feedback to the dog walker, such as vibration, sound, or light. The handle also communicates with the collar and the leash.

The leash tension adjustment function is the process of adjusting the leash tension based on the dog's speed and behavior. The function is performed by the leash, which uses a spring mechanism to increase or decrease the leash length and tension. The function also considers the dog walker's preference and the environmental factors, such as the traffic and the terrain.

The force feedback function is the process of providing force feedback to the dog walker based on the leash tension. The function is performed by the handle, which uses a motor, a speaker, or a LED to generate vibration, sound, or light signals. The function also considers the dog walker's preference and the safety factors, such as the visibility and the noise level.

This diagram shows a line drawing of the leash. The leash is a flexible cord that connects the dog collar and the handle and adjusts the leash tension based on the dog's speed and behavior. The leash has a spring, a wireless transmitter, and a power source. The leash works as follows:

The spring is a device that stretches and contracts the leash based on the force applied by the dog and the dog walker. The spring also controls the leash length and tension.

The wireless transmitter is a device that communicates with the dog collar and the handle. The transmitter sends and receives data and commands to and from the collar and the handle.

The power source is a device that provides the energy for the operation and function of the leash. The power source can be a battery, a solar panel, or a generator.

In another aspect, a device, apparatus methods and system are provided to prevent dog bite or animal attacked. For example when the user is walking and when the vicious dog comes up and barking. And the potentially biting the person. The person can activate a speaker from a smart watch, from a mobile phone or dedicated loud speaker, then come up with a louder sound, such as simulated. A dog language using a bigger meaner dog barking to scare off the potential attacking dog. A. Similarly it can simulate some other wild animals roars like from tiger, lion or bear to scare off potential. Attacks by wild hogs, by bears or other wild animals. This is useful for hiker in the woods or just simply a worker in the neighborhood when there has been faced by. Taking over animal, either domestic or wild, the activated sound. It could be automatically activated or activated by the user to generate the sound either scary to the animal or something like. Subsonic frequencies that are very sensitive to dogs ears. Such sound sometimes even when not being able to hurt by people, can be heard loudly by. Their dog or wild animals and to scare them off. This also involves building a database based on literature and research on what animal language is being spoken in the nature and what is the sound that would be the most scary. To the animals potentially attacking a person, the sound can be a bigger, louder dog barking or a high pitch ultrasound or subsonic frequency. Or simply very loud, or simulating other species response. Or in the case that the animal barking is decoded, talking back the language, either with a friendly. A voice or with a strong and authoritarian voice to either calm down the attacking anymore or scare them off, thereby protecting the user.

### Automatic Animal Deterrent System for Personal Safety

The disclosure relates to an automatic animal deterrent system designed to prevent dog bites and attacks during outdoor activities. By emitting specific sounds mimicking dominant animals or subsonic frequencies, the system scares off potential attackers. The invention enhances personal safety for hikers, workers, and anyone facing aggressive animals.

Encounters with aggressive dogs or wild animals pose risks to individuals. Existing solutions lack adaptability and real-time response to animal behavior.

Automatic Sound Activation: The system activates a speaker via smartwatch, mobile phone, or dedicated loudspeaker. User-triggered or automatic activation based on proximity to aggressive animals. Louder sound output to deter potential attackers.

Animal Language Simulation: Simulates dog language using meaner, dominant dog barking. Optionally simulates other animal roars (e.g., tiger, lion, bear). Subsonic frequencies that are sensitive to dogs' ears.

Database of Animal Sounds: Based on literature and research on animal communication. Identifies sounds most likely to scare off attackers. Includes friendly voice responses for decoded animal barking.

Personal Safety Enhancement: Protects hikers, workers, and individuals facing aggressive animals. Provides real-time deterrent without physical harm. Enhances safety in neighborhoods, parks, and wilderness.

A personal safety system for preventing animal attacks can include the following components:

An automatic sound activation mechanism.

Animal language simulation using dominant dog barking or other species' roars.

Subsonic frequencies for sensitive ears.

A database of animal sounds for effective deterrence.

Wherein the sound output is adjustable based on proximity to the animal.

The system further comprising a user-friendly interface for manual activation.

Wherein the friendly voice responses calm down or scare off decoded animal barking.

The automatic animal deterrent system revolutionizes personal safety by providing real-time protection against aggressive animals. By simulating dominant animal sounds, the invention ensures user safety without causing harm to animals.

This diagram shows the main components and functions of the automatic animal deterrent system for preventing dog bites and attacks during outdoor activities. The system consists of three main components: the sound emitter, the sound selector, and the sound detector. The system performs two main functions: sound emission and sound detection.

The sound emitter is a device that emits specific sounds mimicking dominant animals or subsonic frequencies to scare off potential attackers. The sound emitter can be a speaker, a whistle, or a horn. The sound emitter can be attached to the user's clothing, backpack, or belt.

The sound selector is a device that selects the appropriate sound to emit based on the type and behavior of the attacker. The sound selector can be a switch, a button, or a dial. The sound selector can be integrated with the sound emitter or separated from it.

The sound detector is a device that detects the presence and movement of potential attackers. The sound detector can be a microphone, a radar, or a camera. The sound detector can be attached to the user's clothing, backpack, or belt.

The sound emission function is the process of emitting specific sounds mimicking dominant animals or subsonic frequencies to scare off potential attackers. The function is performed by the sound emitter and the sound selector. The function can be activated manually by the user or automatically by the sound detector.

The sound detection function is the process of detecting the presence and movement of potential attackers. The function is performed by the sound detector. The function can trigger the sound emission function or alert the user.

This diagram shows a line drawing of the sound emitter. The sound emitter is a speaker that emits specific sounds mimicking dominant animals or subsonic frequencies to scare off potential attackers. The sound emitter has a cone, a coil, a magnet, and a power source. The sound emitter works as follows:

The cone is a device that vibrates and produces the sound waves. The cone can be made of paper, plastic, or metal. The cone can have different shapes and sizes to produce different sounds.

The coil is a device that converts the electrical signals into mechanical vibrations. The coil is attached to the cone and moves along with it. The coil can be made of copper, aluminum, or steel. The coil can have different lengths and diameters to produce different sounds.

The magnet is a device that creates a magnetic field that interacts with the coil. The magnet is fixed to the frame and surrounds the coil. The magnet can be made of iron, nickel, or cobalt. The magnet can have different strengths and orientations to produce different sounds.

The power source is a device that provides the energy for the operation and function of the sound emitter. The power source can be a battery, a solar panel, or a generator.

In another aspect, a simulation-based optimization method can be applied to certain job positions training and selection.

For example, one of the airline transport pilot (ATP) requirements was increased to be a minimum of 1500 flying hours in response to public's panic over one accident.

In response to such requirements, many pilots simply fly straight and level using the cheapest aircraft to achieve such minimum hours, while gaining little or no experience that can help reducing probability of future accidents.

Various embodiments of the present disclosure provide a training/selection system, where a certain job position (e.g., ATP) requires a candidate to go through a first predetermined milestone (e.g., 200 hours) of training/evaluation on a simulator, rather than a minimum (e.g., 1500 hours) of actual flying “experience.”

In some embodiments, the simulator training/evaluation emulates real-life situations of airline pilots. For example, the candidates can be on call for certain duty hours, including day, night, short-haul, long-haul, all-weather flight simulations, and randomized failure/emergency scenarios during the simulator sessions.

The candidates are automatically scored during such simulator sessions. If they fail a critical task, or a certain number of less-critical tasks, they will be required to restart the 200-hour evaluation session, or leave the profession all together.

In another aspect, a simulation-based optimization system and method involve constructing individualized model for a patient, including biological, genetic, chemical parameters. A medicine/food supplement will be simulated on the patient's model, to find out potential outcomes, including therapeutic effects and side effects, before the medicine/food supplement is given to the specific patient.

In another aspect, a simulation-based optimization method, is applied to a patent drafting, examination, and litigation process, where the patent draft is first simulated through various stages of searches, invalidity, and other courses, before a significant investment on the patent application is committed.

The method of simulating a process for drafting a patent application includes: searching uncopyrighted literature for references related to an invention disclosure or a draft claim; rewriting content from the references to be embodiments or variations of the invention disclosure or the draft claim; iterating said searching the uncopyrighted literature and said rewriting the content to expand the rewritten content; generating a plurality of draft patent applications based on the rewritten content from a plurality of subsets of the references; selecting an optimal one of the plurality of draft patent applications to be the patent application based on at least one of a patent examination simulation or a patent litigation simulation; wherein the patent examination simulation comprises: searching prior art related to the plurality of draft patent applications; and selecting one or more of the draft patent applications based on simulated allowance probabilities based on the searched prior art; and wherein the patent litigation simulation includes: searching case laws related to the one or more of the plurality of draft patent applications; searching product related to the one or more of the plurality of draft patent applications; simulating infringement probabilities based on the searched product; simulating invalidity proceedings and infringement findings in a number of court systems; and selecting an optimized patent application based on likelihood of winning the invalidity proceedings and infringement findings.

In some embodiments, the patent examination process is outsourced to the public. For example, rather than having tens of thousands of patent examiners acting as both judges and juries, the above prior art search and examination tasks can be outsourced to the public, and the remaining few percent of patent examiners will only serve as editors to ensure non-biased public opinions be included in patent file histories.

Crowdsourcing has been shown to be effective in other areas. For example, Wikipedia™ is known to have accuracy rates rival those of officially published encyclopedias. By the same token, the outsourced patent examination process likely will improve patent examination accuracy and quality.

Compared with non-expert patent examiners spending merely a few hours completing the tasks of reading patent applications, the outsourced patent search and examination processes will likely draw industry experts, and parties of interests to get involved in depth of the search and examination processes. For some patent applications that draw less attention from the public, the patent office can subcontract patent examination to a number of industrial and academic experts with service fees, which would still be significantly cheaper than maintaining a full staff of non-expert examiners.

For some applications that draw substantial oppositions from potential competitors, the patent office can subcontract part of the examination and search to non-biased experts to balance the oppositions and prior art search results from the potential competitors. The remaining patent “examiners” would serve as an impartial party to weigh in evidences and arguments provided by all parties, similar to the role of judges and editors.

By examining patent applications using the above methods and systems, the high cost of later patent invalidity and litigation proceedings is shifted to the first line of patent examination process, at a much lower cost, supported by the public. The ineffectiveness of the current first line of patent examination process is demonstrated by that among the ˜50% of the patent applications that are allowed, ˜50% or more are later invalidated, yet among which ˜50% or more are later reversed or invalidated by higher courts.

In the method and system for outsourcing the patent examination process to the public according to various embodiments of the present disclosure, advantageously, by leveraging crowdsourcing, the accuracy and quality of patent examinations can be improved, the cost can be reduced, and the impartiality of the examination process can be enhanced.

Indeed, traditional patent examination processes involve a large number of patent examiners who act as both judges and juries. This traditional model adopted by many countries has several limitations, including high costs, limited expertise, and potential biases. To address these challenges, various embodiments of the present disclosure provide an outsourced patent examination process that utilizes public participation and industry experts.

In some embodiments, the patent examination process is mostly outsourced to the public. Rather than having tens of thousands of patent examiners acting as both judges and juries, the prior art search and examination tasks are outsourced to the public. The remaining few percent of patent examiners serve as editors to ensure that non-biased public opinions are included in patent file histories. Crowdsourcing has been shown to be effective in other areas, such as Wikipedia™ which has accuracy rates rivaling those of officially published encyclopedias. Similarly, the outsourced patent examination process is likely to improve patent examination accuracy and quality.

Compared to non-expert patent examiners spending merely a few hours completing the tasks of reading patent applications, the outsourced patent search and examination processes will likely draw industry experts and parties of interest to engage in-depth in the search and examination processes. For patent applications that draw less attention from the public, the patent office can subcontract the examination to a number of industrial and academic experts with service fees, which would still be significantly cheaper than maintaining a full staff of non-expert examiners.

For applications that draw substantial opposition from potential competitors, the patent office can subcontract part of the examination and search to non-biased experts to balance the opposition and prior art search results from the potential competitors. The remaining patent examiners would serve as impartial parties to weigh in evidence and arguments provided by all parties, similar to the role of judges and editors.

By examining patent applications using the above methods and systems, the high cost of later patent invalidity and litigation proceedings is shifted to the first line of the patent examination process, at a much lower cost, supported by the public. The ineffectiveness of the current first line of the patent examination process is demonstrated by the fact that among the approximately 50% of patent applications that are allowed, 50% or more are later invalidated, yet among which 50% or more are later reversed or invalidated by higher courts.

A detailed methodology for outsourcing the patent examination process can include one or more of the following steps.

Step 1, public involvement.

The patent examination process is opened to the public, allowing individuals to participate in prior art searches and examination tasks.

Public participants are incentivized through rewards, recognition, or other motivational factors to ensure active and unbiased participation.

In some embodiments, a “bounty” can be given to those who located the most relevant prior art.

Step 2, editorial oversight.

A small percentage of patent examiners act as editors to review and compile non-biased public opinions into the patent file histories.

Editors ensure that all relevant information is accurately represented and that any potential biases are mitigated.

Step 3, industry and academic expert involvement.

For patent applications that draw less public attention, the patent office can subcontract the examination to industrial and academic experts with service fees.

Experts provide in-depth analysis and evaluation, leveraging their specialized knowledge to improve the examination process.

Step 4, balancing oppositions.

For applications with substantial oppositions from potential competitors, the patent office can subcontract part of the examination and search to non-biased experts.

This approach balances the opposition and prior art search results, ensuring a fair and impartial examination process.

The outsourcing model significantly reduces the costs associated with maintaining a full staff of non-expert examiners.

The high cost of patent invalidity and litigation proceedings is shifted to the initial patent examination process, resulting in overall cost savings.

The present invention provides an innovative method and system for outsourcing the patent examination process to the public and industry experts. By leveraging crowdsourcing and expert involvement, the invention aims to improve the accuracy, quality, and impartiality of patent examinations while reducing costs and enhancing the overall efficiency of the patent examination system.

In another aspect, an investment is simulated in a model of market, including individual and institution investors represented by “carriers” in a Monte Carlo model, where the simulated investment is run through all sorts of possibilities, based on probability equations, to generate simulated returns in various possible scenarios for an investor to consider.

In another aspect, traffic is simulated based on probabilities of various driving scenarios in a Monte Carlo model, and a driver or autopilot is advised of all possible routes and actions based on probabilities, and provide best action items for highest probabilities to achieve the driver or autopilot's objectives.

In some embodiments, a periscope is provided on a vehicle, which can extend when there are no obstacles, and can take videos of real-time nearby traffic, to advise the driver or autopilot to change lanes to achieve an optimal goal.

For the convenience of description, the components of the apparatus may be divided into various modules or units according to functions which may be separately described. Certainly, when various embodiments of the present disclosure are carried out, the functions of these modules or units can be achieved utilizing one or more equivalent units of hardware or software as will be recognized by those having skill in the art.

The various device components, units, blocks, or portions may have modular configurations, or are composed of discrete components, but nonetheless can be referred to as “modules” in general. In other words, the “components,” “modules” or “units” referred to herein may or may not be in modular forms.

Persons skilled in the art should understand that the embodiments of the present disclosure can be provided for a method, system, or computer program product. Thus, various embodiments of the present disclosure can be in form of all-hardware embodiments, all-software embodiments, or a mix of hardware-software embodiments. Moreover, various embodiments of the present disclosure can be in form of a computer program product implemented on one or more computer-applicable memory media (including, but not limited to, disk memory, CD-ROM, optical disk, etc.) containing computer-applicable procedure codes therein.

Various embodiments of the present disclosure are described with reference to the flow diagrams and/or block diagrams of the method, apparatus (system), and computer program product of the embodiments of the present disclosure. It should be understood that computer program instructions realize each flow and/or block in the flow diagrams and/or block diagrams as well as a combination of the flows and/or blocks in the flow diagrams and/or block diagrams. These computer program instructions can be provided to a processor of a general-purpose computer, a special-purpose computer, an embedded memory, or other programmable data processing apparatuses to generate a machine, such that the instructions executed by the processor of the computer or other programmable data processing apparatuses generate a device for performing functions specified in one or more flows of the flow diagrams and/or one or more blocks of the block diagrams.

These computer program instructions can also be stored in a computer-readable memory, such as a non-transitory computer-readable storage medium. The instructions can guide the computer or other programmable data processing apparatuses to operate in a specified manner, such that the instructions stored in the computer-readable memory generate an article of manufacture including an instruction device. The instruction device performs functions specified in one or more flows of the flow diagrams and/or one or more blocks of the block diagrams.

These computer program instructions may also be loaded on the computer or other programmable data processing apparatuses to execute a series of operations and steps on the computer or other programmable data processing apparatuses, such that the instructions executed on the computer or other programmable data processing apparatuses provide steps for performing functions specified ill one or more flows of the flow diagrams and/or one or more blocks of the block diagrams.

Implementations of the subject matter and the operations described in this disclosure can be implemented in digital electronic circuitry, or in computer software, firmware, or hardware, including the structures disclosed herein and their structural equivalents, or in combinations of one or more of them. Implementations of the subject matter described in this disclosure can be implemented as one or more computer programs, i.e., one or more modules of computer program instructions, encoded on one or more computer storage medium for execution by, or to control the operation of, data processing apparatus.

Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them.

Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, drives, or other storage devices). Accordingly, the computer storage medium may be tangible.

The operations described in this disclosure can be implemented as operations performed by a data processing apparatus on data stored on one or more computer-readable storage devices or received from other sources.

Processors suitable for the execution of a computer program such as the instructions described above include, by way of example, both general and special purpose microprocessors, and any one or more processors of any kind of digital computer. Generally, a processor will receive instructions and data from a read-only memory, or a random-access memory, or both. Elements of a computer can include a processor configured to perform actions in accordance with instructions and one or more memory devices for storing instructions and data.

The processor or processing circuit can be implemented by one or a plurality of application specific integrated circuits (ASICs), digital signal processors (DSPs), digital signal processing devices (DSPDs), programmable logic devices (PLDs), field programmable gate arrays (FPGA), controllers, microcontrollers, microprocessors, general processors, or other electronic components, so as to perform the above image capturing method.

Implementations of the subject matter and the operations described in this disclosure can be implemented in digital electronic circuitry, or in computer software, firmware, or hardware, including the structures disclosed herein and their structural equivalents, or in combinations of one or more of them. Implementations of the subject matter described in this disclosure can be implemented as one or more computer programs, i.e., one or more portions of computer program instructions, encoded on one or more computer storage medium for execution by, or to control the operation of, data processing apparatus.

Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

In some implementations, the model can reside on local processing circuits and storage devices, and the training of the model can also be performed locally. In some implementations, the model and the training can be remotely or distributed, such as in a cloud.

Data, such as the inputs, the outputs, and model predictions, can be presented to users/operators on display screens, such as organic light-emitting diode (OLED) displays screens and liquid-crystal display (LCD) screens located on a manufacturing line and/or in a control room.

Although preferred embodiments of the present disclosure have been described, persons skilled in the art can alter and modify these embodiments once they know the fundamental inventive concept. Therefore, the attached claims should be construed to include the preferred embodiments and all the alternations and modifications that fall into the extent of the present disclosure.

The description is only used to help understanding some of the possible methods and concepts. Meanwhile, those of ordinary skill in the art can change the specific implementation manners and the application scope according to the concepts of the present disclosure. The contents of this specification therefore should not be construed as limiting the disclosure.

In the foregoing method embodiments, for the sake of simplified descriptions, the various steps are expressed as a series of action combinations. However, those of ordinary skill in the art will understand that the present disclosure is not limited by the particular sequence of steps as described herein.

According to some other embodiments of the present disclosure, some steps can be performed in other orders, or simultaneously, omitted, or added to other sequences, as appropriate.

Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing may be utilized.

In addition, those of ordinary skill in the art will also understand that the embodiments described in the specification are just some of the embodiments, and the involved actions and portions are not all exclusively required, but will be recognized by those having skill in the art whether the functions of the various embodiments are required for a specific application thereof.

Various embodiments in this specification have been described in a progressive manner, where descriptions of some embodiments focus on the differences from other embodiments, and same or similar parts among the different embodiments are sometimes described together in only one embodiment.

It should also be noted that in the present disclosure, relational terms such as first and second, etc., are only used to distinguish one entity or operation from another entity or operation, and do not necessarily require or imply these entities having such an order or sequence. It does not necessarily require or imply that any such actual relationship or order exists between these entities or operations.

Moreover, the terms “include,” “including,” or any other variations thereof are intended to cover a non-exclusive inclusion such that a process, method, article, or apparatus that comprises a list of elements including not only those elements but also those that are not explicitly listed, or other elements that are inherent to such processes, methods, goods, or equipment.

In the case of no more limitation, the element defined by the sentence “includes a . . . ” does not exclude the existence of another identical element in the process, the method, the commodity, or the device including the element.

In the descriptions, with respect to device(s), terminal(s), etc., in some occurrences singular forms are used, and in some other occurrences plural forms are used in the descriptions of various embodiments. It should be noted, however, that the single or plural forms are not limiting but rather are for illustrative purposes. Unless it is expressly stated that a single device, or terminal, etc. is employed, or it is expressly stated that a plurality of devices, or terminals, etc. are employed, the device(s), terminal(s), etc. can be singular, or plural.

Based on various embodiments of the present disclosure, the disclosed apparatuses, devices, and methods can be implemented in other manners. For example, the abovementioned terminals devices are only of illustrative purposes, and other types of terminals and devices can employ the methods disclosed herein.

Dividing the terminal or device into different “portions,” “regions” “or “components” merely reflect various logical functions according to some embodiments, and actual implementations can have other divisions of “portions,” “regions,” or “components” realizing similar functions as described above, or without divisions. For example, multiple portions, regions, or components can be combined or can be integrated into another system. In addition, some features can be omitted, and some steps in the methods can be skipped.

Those of ordinary skill in the art will appreciate that the portions, or components, etc. in the devices provided by various embodiments described above can be configured in the one or more devices described above. They can also be located in one or multiple devices that is (are) different from the example embodiments described above or illustrated in the accompanying drawings. For example, the circuits, portions, or components, etc. in various embodiments described above can be integrated into one module or divided into several sub-modules.

The numbering of the various embodiments described above are only for the purpose of illustration, and do not represent preference of embodiments.

All references referred to in the present disclosure are incorporated by reference in their entirety. Although specific embodiments have been described above in detail, the description is merely for purposes of illustration. It should be appreciated, therefore, that many aspects described above are not intended as required or essential elements unless explicitly stated otherwise. Various modifications of, and equivalent acts corresponding to, the disclosed aspects of the exemplary embodiments, in addition to those described above, can be made by a person of ordinary skill in the art, having the benefit of the present disclosure, without departing from the spirit and scope of the disclosure defined in the following claims, the scope of which is to be accorded the broadest interpretation so as to encompass such modifications and equivalent structures.

What is claimed is:

1. An method for organizing and delivering content, comprising:
searching for online content based on specification or preference of a user;
automatically categorizing and organizing content based on authority specifications;
delivering the automatically categorized and organized content to the user;
collecting fees from user for part of the automatically categorized and organized content that require the fees; and
automatically distributing royalties to content owners from the collected fees.

2. The method of claim 1, wherein the specification or preference comprises a specification for a federal aviation administration (FAA) pilot's license requirements; and wherein the authority specifications comprise FAA publications for pilot's manuals.

3. The method of claim 2, wherein the automatically categorized and organized content comprises structured lessons following the FAA publications for pilot's manuals.

4. The method of claim 3, wherein the structured lessons comprise videos from content creators.

5. The method of claim 4, further comprising a training/selection process for a position based on simulator results.

6. The method of claim 5, wherein the position is an FAA pilot's position.

7. The method of claim 6, further comprising requiring a candidate to go through a first predetermined milestone of training/evaluation on a flight simulator.

8. The method of claim 7, wherein the flight simulator is configured to emulate real-life situations of airline pilots.

9. The method of claim 8, further comprising the candidate to be on call for certain duty hours, including day, night, short-haul, long-haul, all-weather flight simulations, and randomized failure/emergency scenarios during simulator sessions.

10. The method of claim 9, further comprising automatically scoring the candidate during the simulator sessions.

11. The method of claim 10, wherein the automatically scoring comprises failing the candidate if the candidate fails a critical task, or a predetermined number of less-critical tasks.

12. The method of claim 11, further comprising requiring the candidate to restart the simulator sessions before the first predetermined milestone.

13. The method of claim 1, further comprising a process of publishing, including:
identifying a plurality of clients who desire to have their proposed works published;
subcontracting the works to one or more writers; and
publishing the works for the clients.

14. The method of claim 13, wherein the works comprise one or more of: books, portable media, and websites, and are in one or more of the forms: printed copy, multimedia, movie, and TV.

15. The method of claim 14, further comprising a business entity getting paid by the clients, and the business entity paying the writers.

16. The method of claim 15, further comprising:
the writers visiting the clients regularly;
the writers presenting progress reports to a business entity; and
the business entity presenting edited work products to the clients.

17. The method of claim 16, wherein said identifying the plurality of clients includes advertising service of a business entity on a website, and identifying the plurality of clients from potential clients' response to the advertisement.
